(19) United States
(12) Patent Application Publication
(10) Pub. No.: US 2026/0113694 A1
(43) Pub. Date: Apr. 23, 2026

(54) METHOD AND AN APPARATUS FOR USER EQUIPMENT STATUS ASSISTANCE OPERATION

(71) Applicant: BEIJING XIAOMI MOBILE SOFTWARE CO., LTD., Beijing (CN)

(72) Inventors: Jinhua WU, Beijing (CN); Yang SHEN; Jianfeng QI, Beijing (CN); Deqian WANG, Beijing (CN)

(21) Appl. No.: 19/115,194

(22) PCT Filed: Sep. 26, 2022
(86) PCT No.: PCT/CN2022/121508

§ 371 Date: Mar. 25, 2025

(51) Int. Cl. H04W 48/16; H04W 8/24

(52) U.S. Cl. CPC H04W 48/16; H04W 8/24

(57) ABSTRACT

A method for a user equipment (UE) status assistance operation, performed by a UE, includes: generating UE status assistance operation information according to status information of the UE; and sending the UE status assistance operation information to an access and mobility management function (AMF) via a radio access network (RAN).

### CROSS-REFERENCE TO RELATED APPLICATIONS

The present application is a U.S. national phase of International Application No. PCT/CN2022/121508, filed on Sep. 26, 2022, the entire disclosure of which is incorporated herein by reference for all purposes.

### FIELD

The present disclosure relates to the field of communication technologies, and in particular relates to a method and an apparatus for a user equipment (UE) status assistance operation, a device and a storage medium.

### BACKGROUND

Mobile media services, extended reality (XR) services such as augmented reality (AR)/virtual reality (VR), a cloud gaming, a video-based machine or unmanned aerial vehicle remote control and other services will provide higher and higher traffic for a network. In addition to a video-audio stream, the XR services also involve a multi-modal data flow, such as a bio-tactual perceptual data flow. A 5th generation mobile communication technology system (5GS) adopts a common quality of service (QoS) mechanism to process various types of data services including the XR services, which may not effectively support the differentiated uplink and downlink requirements, such as the asymmetric requirements of uplink data reliability and downlink data bandwidth. Moreover, an XR media data flow has features such as high bandwidth, low delay and high reliability, which leads to high energy consumption. Therefore, how to balance power consumption and quality of experience (QoE) is an urgent problem to be solved.

### SUMMARY

According to a first aspect of embodiments of the present disclosure, there is provided a method for a user equipment (UE) status assistance operation, performed by a UE, including: generating UE status assistance operation information according to status information of the UE; and sending the UE status assistance operation information to an access and mobility management function (AMF) via a radio access network (RAN).

According to a second aspect of embodiments of the present disclosure, there is provided a method for a user equipment (UE) status assistance operation, performed by an access and mobility management function (AMF), including: receiving UE status assistance operation information; and sending the UE status assistance operation information to a protocol control frame (PCF).

According to a third aspect of embodiments of the present disclosure, there is provided a method for a user equipment (UE) status assistance operation, performed by a protocol control frame (PCF), including: receiving UE status assistance operation information sent by an access and mobility management function (AMF); and generating or updating a policy-associated rule according to the UE status assistance operation information.

According to a fourth aspect of embodiments of the present disclosure, there is provided a method for a user equipment (UE) status assistance operation, performed by a core network, including: receiving UE status assistance operation information; and generating or updating a policy-associated rule according to the UE status assistance operation information.

According to a fifth aspect of embodiments of the present disclosure, there is provided a user equipment (UE), including: a processor; and a memory, in which the memory is configured to store a computer program, and the processor is configured to execute the computer program stored in the memory to cause the UE to perform the method provided in the first aspect.

According to a sixth aspect of embodiments of the present disclosure, there is provided an access and mobility management function (AMF), including: a processor; and a memory, in which the memory is configured to store a computer program, and the processor is configured to execute the computer program stored in the memory to cause the AMF to perform the method provided in the second aspect.

According to a seventh aspect of embodiments of the present disclosure, there is provided a protocol control frame (PCF), including: a processor; and a memory, in which the memory is configured to store a computer program, and the processor is configured to execute the computer program stored in the memory to cause the PCF to perform the method provided in the third aspect.

According to an eighth aspect of embodiments of the present disclosure, there is provided a core network, including: a processor; and a memory, in which the memory is configured to store a computer program, and the processor is configured to execute the computer program stored in the memory to cause the core network to perform the method provided in the fourth aspect.

According to another aspect of embodiments of the present disclosure, there is provided a communication device, including: a processor; and an interface circuit, in which the interface circuit is configured to receive code instructions and transmit the code instructions to the processor; and the processor is configured to run the code instructions to perform the method provided in the above aspect.

According to another aspect of embodiments of the present disclosure, there is provided a computer-readable storage medium, configured to store instructions that, when executed, cause the method provided in the above aspect.

According to another aspect of embodiments of the present disclosure, there is provided a system for a user equipment (UE) status assistance operation, including: a UE configured to generate UE status assistance operation information according to status information of the UE; in which the UE is further configured to send the UE status assistance operation information to an access and mobility management function (AMF) via a radio access network (RAN); the AMF is configured to receive the UE status assistance operation information; the AMF is further configured to send the UE status assistance operation information to a protocol control frame (PCF); the PCF is configured to receive the UE status assistance operation information sent by the AMF; and the PCF is further configured to generate or update a policy-associated rule according to the UE status assistance operation information.

### BRIEF DESCRIPTION OF THE DRAWINGS

The above and/or additional aspects and advantages of the present disclosure will become apparent and more readily appreciated from the following descriptions of embodiments made with reference to the drawings, in which:

FIG. 1 is a flow chart illustrating a method for a user equipment (UE) status assistance operation according to an embodiment of the present disclosure;

FIG. 2 is a flow chart illustrating a method for a UE status assistance operation according to an embodiment of the present disclosure;

FIG. 3 is a flow chart illustrating a method for a UE status assistance operation according to another embodiment of the present disclosure;

FIG. 4 is an interactive schematic diagram illustrating a method for a UE status assistance operation according to another embodiment of the present disclosure;

FIG. 5 is a flow chart illustrating a method for a UE status assistance operation according to another embodiment of the present disclosure;

FIG. 6 is an interactive schematic diagram illustrating a method for a UE status assistance operation according to another embodiment of the present disclosure;

FIG. 7 is a flow chart illustrating a method for a UE status assistance operation according to another embodiment of the present disclosure;

FIG. 8 is an interactive schematic diagram illustrating a method for a UE status assistance operation according to another embodiment of the present disclosure;

FIG. 9 is a flow chart illustrating a method for a UE status assistance operation according to another embodiment of the present disclosure;

FIG. 10 is an interactive schematic diagram illustrating a method for a UE status assistance operation according to another embodiment of the present disclosure;

FIG. 11 is a flow chart illustrating a method for a UE status assistance operation according to another embodiment of the present disclosure;

FIG. 12 is a flow chart illustrating a method for a UE status assistance operation according to another embodiment of the present disclosure;

FIG. 13 is a flow chart illustrating a method for a UE status assistance operation according to another embodiment of the present disclosure;

FIG. 14 is an interactive schematic diagram illustrating a method for a UE status assistance operation according to another embodiment of the present disclosure;

FIG. 15 is a flow chart illustrating a method for a UE status assistance operation according to another embodiment of the present disclosure;

FIG. 16 is a flow chart illustrating a method for a UE status assistance operation according to another embodiment of the present disclosure;

FIG. 17 is a flow chart illustrating a method for a UE status assistance operation according to another embodiment of the present disclosure;

FIG. 18 is a flow chart illustrating a method for a UE status assistance operation according to another embodiment of the present disclosure;

FIG. 19 is a flow chart illustrating a method for a UE status assistance operation according to another embodiment of the present disclosure;

FIG. 20 is a flow chart illustrating a method for a UE status assistance operation according to another embodiment of the present disclosure;

FIG. 21 is a flow chart illustrating a method for a UE status assistance operation according to another embodiment of the present disclosure;

FIG. 22 is a flow chart illustrating a method for a UE status assistance operation according to another embodiment of the present disclosure;

FIG. 23 is a flow chart illustrating a method for a UE status assistance operation according to another embodiment of the present disclosure;

FIG. 24 is a flow chart illustrating a method for a UE status assistance operation according to another embodiment of the present disclosure;

FIG. 25 is a flow chart illustrating a method for a UE status assistance operation according to another embodiment of the present disclosure;

FIG. 26 is a schematic structural diagram illustrating a system for a UE status assistance operation according to an embodiment of the present disclosure;

FIG. 27 is a schematic structural diagram illustrating an apparatus for a UE status assistance operation according to an embodiment of the present disclosure;

FIG. 28 is a schematic structural diagram illustrating an apparatus for a UE status assistance operation according to another embodiment of the present disclosure;

FIG. 29 is a schematic structural diagram illustrating an apparatus for a UE status assistance operation according to another embodiment of the present disclosure;

FIG. 30 is a schematic structural diagram illustrating an apparatus for a UE status assistance operation according to another embodiment of the present disclosure;

FIG. 31 is a block diagram illustrating a UE according to an embodiment of the present disclosure;

FIG. 32 is a block diagram illustrating a network device according to an embodiment of the present disclosure.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with embodiments of the present disclosure. Instead, they are merely examples of apparatuses and methods consistent with aspects related to embodiments of the present disclosure as recited in the appended claims.

Terms used herein in embodiments of the present disclosure are only for the purpose of describing specific embodiments, but should not be construed to limit embodiments of the present disclosure. As used in embodiments of the present disclosure and the appended claims, “a/an” and “the” in singular forms are intended to include plural forms, unless clearly indicated in the context otherwise. It should also be understood that, the term “and/or” used herein represents and contains any or all possible combinations of one or more associated listed items.

It should be understood that, although terms such as “first,” “second” and “third” may be used in embodiments of the present disclosure for describing various information, these information should not be limited by these terms. These terms are only used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context.

A network element or a network function involved in embodiments of the present disclosure may be implemented by an independent hardware device or by software in the hardware device, which is not limited by embodiments of the present disclosure.

Mobile media services, extended reality (XR) services such as augmented reality (AR)/virtual reality (VR), a cloud gaming, a video-based machine or unmanned aerial vehicle remote control and other services are expected to contribute to higher and higher traffic for a 5th generation (5G) network. In addition to a video-audio stream, the XR services further involve a multi-modal data flow, such as a bio-tactual perceptual data flow. These multi-modal data are data input from the same device or from different devices (including a sensor) describing the same service or application, which data may be output to one or more destination device terminals. Data flows in the multi-modal data tend to have some or even strong correlation, such as synchronization of audio and video streams, synchronization of tactile and visual and the like. Some common features are existed in the data flow itself of such media services, between the data flows, and the demand for network transmission of these service data flows, and the effective identification and utilization of these features will be more conducive to transmission and control of a network and a service, and more conducive to service assurance and user experience.

In the related art, a 5th generation mobile communication technology system (5GS) adopts a common quality of service (QoS) mechanism to process various types of data services including the XR services, which does not fully take into account the feature of XR media services, and may not effectively support the differentiated uplink and downlink requirements, such as the asymmetric requirements of uplink data reliability and downlink data bandwidth. Moreover, an XR media data flow has features such as high bandwidth, low delay and high reliability, which leads to high energy consumption. Further, the energy consumption solution is also an important factor which affects the service usage and user experience.

In the related art, more efficient codecs require more power consumption and higher reliability. In addition, higher throughput and lower delay budgets further require more power consumption and more network resources. Therefore, users are increasingly concerned about how to support the trade-off between the throughput/delay/reliability and the power consumption (e.g. a battery life of a device).

In the related art, a certain local energy-saving solution of a user equipment (UE) is existed, i.e. the energy-saving solution is determined by the UE alone. However, the energy-saving solution does not involve performing policy control and charging (PCC) policy-making and QoS authorization and dynamic adjustment of service data flow authorization according to different status information of the UE, including a battery level, a battery life, a powered mode including battery powered or mains/wall powered and overheating, in combination with corresponding service characteristics.

In the related art, the UE may provide status information of the UE to a network to support the trade-off between the throughput/delay/reliability and the power consumption (e.g. a battery life of a device). However, since there are many kinds of internal information of UE, and the internal information of UE will be exposed to the network, the security of internal information of UE is poor.

Hereinafter, a method and an apparatus for a UE status assistance operation, a device and a storage medium provided by embodiments of the present disclosure will be described in detail with reference to the accompanying drawings.

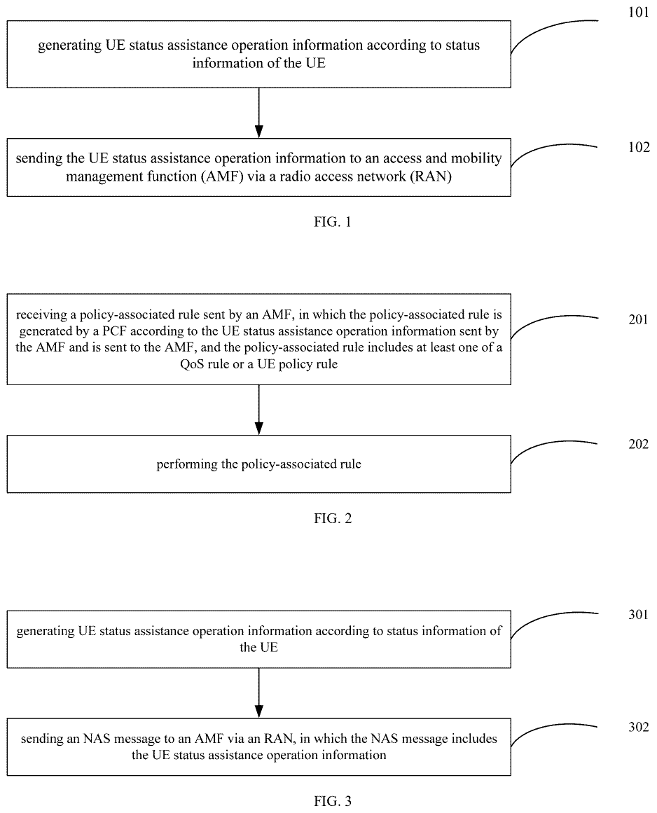

FIG. 1 is a flow chart illustrating a method for a UE status assistance operation according to an embodiment of the present disclosure. The method is performed by a UE. As shown in FIG. 1, the method may include the following steps.

In step 101, UE status assistance operation information is generated according to status information of the UE.

In step 102, the UE status assistance operation information is sent to an access and mobility management function (AMF) via a radio access network (RAN).

It should be noted that, in an embodiment of the present disclosure, the UE may be a device that provides voice and/or data connectivity to a user. The UE may communicate with one or more core networks via the RAN. The UE may be an Internet of Things terminal, such as a sensor device, a mobile phone (or referred to as a “cellular” phone) and a computer with an Internet of Things terminal. For example, the UE may be a fixed, portable, pocket-sized, handheld, computer built-in or vehicle-mounted apparatus. For example, the UE may be a station (STA), a subscriber unit, a subscriber station, a mobile station, a mobile, a remote station, an access point, a remote terminal, an access terminal, a user terminal or a user agent. Alternatively, the UE may also be a device of an unmanned aerial vehicle. Alternatively, the UE may also be a vehicle-mounted device, for example, a driving computer with a wireless communication function, or a wireless communication device externally connected with a driving computer. Alternatively, the UE may be a roadside device, such as a street lamp, a signal lamp or other roadside devices with a wireless communication function.

Further, in an embodiment of the present disclosure, the UE status assistance operation information may include, for example, a UE status assistance operation indication, UE status assistance operation information, or a UE status assistance operation requirement and the like.

Further, in an embodiment of the present disclosure, the method further includes: receiving a policy-associated rule sent by the AMF, in which the policy-associated rule is generated by a protocol control frame (PCF) according to the UE status assistance operation information sent by the AMF and sent to the AMF, and the policy-associated rule includes at least one of a QoS rule or a UE policy rule; and performing the policy-associated rule.

Further, in an embodiment of the present disclosure, the UE policy rule is a PCC rule, in which the PCC rule may be sent directly to the AMF by, for example, the PCF. The policy-associated rule further includes the QoS rule, in which the QoS rule may be sent by, for example, the PCF to the AMF via a session management function (SMF). That is, the PCF may send the PCC rule to the SMF, and the SMF may convert the PCC rule into the QoS rule and send the QoS rule to the AMF. Specifically, the SMF may generate a QoS rule corresponding to a standard delay format (SDF) or a QoS flow according to the PCC rule. The SMF may send the QoS rule to a unified power format (UPF), the RAN or the UE for execution.

In an embodiment of the present disclosure, the UE performs the policy-associated rule, for example, a guaranteed flow bit rate (GFBR) update may be performed on a guaranteed bit rate (GBR) data flow, including lowering or increasing a GFBG. For example, an aggregate maximum bit rate (AMBR)-associated update may further be performed on a non-guaranteed bit rate (non-GBR) data flow, including lowering or increasing an AMBR. For example, an update of the AMBR may further be performed, and there are three levels, i.e., a UE-AMBR, a session-AMBR and a UE-Slice-AMBR. An update of the UE-Slice-AMBR includes update of the GBR data flow and the non-GBR data flow.

In an embodiment of the present disclosure, the status information of the UE includes at least one of: a battery level; a battery life; a powered mode; a temperature status; an overheating status; or a load status.

For example, in an embodiment of the present disclosure, the UE status assistance operation information includes at least one of: a UE status assistance operation mode; a UE status assistance operation mode indication; threshold information; a UE status assistance operation mode function; priority information; or importance level information.

Further, in an embodiment of the present disclosure, the UE status assistance operation mode is applied for matching traffic and an associated parameter. The associated parameter may be, for example, a parameter related to a QoS.

Further, in an embodiment of the present disclosure, the UE status assistance operation mode indication indicates an autonomous operation or a UE-assistance operation in a case where the UE status assistance operation mode is a mode set, in which the mode set includes at least one of a load balancing mode, a power consumption balancing mode, or a packet data unit (PDU) set-based QoS handling mode.

Further, in an embodiment of the present disclosure, the threshold information includes at least one of: a maximum round-trip time (RTT); a maximum packet loss rate; a GFBR; or an AMBR.

Further, in an embodiment of the present disclosure, the UE status assistance operation mode function is configured to determine whether to apply the mode set for the matching traffic, in which the mode set includes at least one of the load balancing mode, the power consumption balancing mode, or the PDU set-based QoS handling mode.

Further, in an embodiment of the present disclosure, the priority information is configured to determine a priority of whether to apply the QoS for the matching traffic, in which the priority is greater than a priority threshold. For example, the priority is configured to determine whether to apply the QoS for a high priority of the matching traffic.

Further, in an embodiment of the present disclosure, the importance level information is configured to determine an importance level of whether to apply the QoS for the matching traffic, in which the importance level is greater than an importance level threshold.

Further, in an embodiment of the present disclosure, a detailed description of the UE status assistance operation information may be shown in Table 1, for example.

TABLE 1

| Information name | Description | Category | Scope |
|---|---|---|---|
| UE status assistance | the UE status assistance operation mode is applied for | Mandatory | PDU |
| operation mode | the matching traffic and the associated parameter | | context |
| UE status assistance | the UE status assistance operation mode indication | Optional | PDU |
| operation mode | indicates the autonomous operation or the UE- | | context |
| indication | assistance operation in a case where the UE status | | |
| | assistance operation mode is the mode set, in which the | | |
| | mode set includes at least one of the load balancing | | |
| | mode, the power consumption balancing mode, or the | | |
| | PDU set-based QoS handling mode | | |
| threshold | the threshold information includes at least one of: the | Optional | PDU |
| information | maximum RTT; the maximum packet loss rate; the | | context |
| | GFBR; or the AMBR | | |
| UE status assistance | the UE status assistance operation mode function is | Optional | PDU |
| operation mode | configured to determine whether to apply the mode set | | context |
| function | for the matching traffic, in which the mode set includes | | |
| | at least one of the load balancing mode, the power | | |
| | consumption balancing mode, or the PDU set-based | | |
| | QoS handling mode | | |
| priority information | the priority information is configured to determine the | Optional | PDU |
| or importance level | priority of whether to apply the QoS for the matching | | context |
| information | traffic, in which the priority is greater than the priority | | |
| | threshold; the importance level information is | | |
| | configured to determine the importance level of | | |
| | whether to apply the QoS for the matching traffic, in | | |
| | which the importance level is greater than the | | |
| | importance level threshold | | |

For example, in an embodiment of the present disclosure, besides the matching traffic, the UE status assistance operation mode is also applied to other matching scenarios. For example, the UE status assistance operation mode is further suitable to match different granularities of a data packet, a PDU set, the QoS flow, a PDU session, a UE slice, UE, all UEs of any relationship management (XRM) service group and the like.

Further, in an embodiment of the present disclosure, sending the UE status assistance operation information to the AMF via the RAN includes: sending a non-access stratum (NAS) message to the AMF via the RAN, in which the NAS message includes the UE status assistance operation information.

Further, in an embodiment of the present disclosure, sending the UE status assistance operation information to the AMF via the RAN includes: sending a next generation application protocol (NGAP) message to the AMF via the RAN, in which the NGAP message includes the UE status assistance operation information.

Further, in an embodiment of the present disclosure, sending the UE status assistance operation information to the AMF via the RAN includes: receiving a request for the UE status assistance operation information sent by the AMF via the RAN; and sending the UE status assistance operation information to the AMF via the RAN in response to the request.

Further, in an embodiment of the present disclosure, sending the UE status assistance operation information to the AMF via the RAN includes: sending the UE status assistance operation information to the AMF via the RAN in response to the UE performing a communication recovery process.

In summary, in the embodiments of the present disclosure, the UE status assistance operation information that is sent to the AMF via the RAN is generated according to the status information of the UE. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating the policy-associated rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 2 is a flow chart illustrating a method for a UE status assistance operation according to an embodiment of the present disclosure. The method is performed by a UE. As shown in FIG. 2, the method may include the following steps.

In step 201, a policy-associated rule sent by an AMF is received, in which the policy-associated rule is generated by a PCF according to the UE status assistance operation information sent by the AMF and is sent to the AMF, and the policy-associated rule includes at least one of a QoS rule or a UE policy rule.

In step 202, the policy-associated rule is performed.

Further, in an embodiment of the present disclosure, the UE policy rule is a PCC rule, in which the PCC rule may be sent directly to the AMF by, for example, the PCF. The policy-associated rule further includes the QoS rule, in which the QoS rule may be sent by, for example, the PCF to the AMF via an SMF. That is, the PCF may send the PCC rule to the SMF, and the SMF may convert the PCC rule into the QoS rule and send the QoS rule to the AMF. Specifically, the SMF may generate a QoS rule corresponding to an SDF or a QoS flow according to the PCC rule. The SMF may send the QoS rule to a UPF, the RAN or the UE for execution.

In summary, in the embodiments of the present disclosure, the policy-associated rule sent by the AMF is received, in which the policy-associated rule is generated by the PCF according to the UE status assistance operation information sent by the AMF and is sent to the AMF, and the policy-associated rule includes at least one of the QoS rule or the UE policy rule; and the policy-associated rule is performed. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating the policy-associated rule. Embodiments of the present disclosure specifically describe a solution for receiving and performing the policy-associated rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

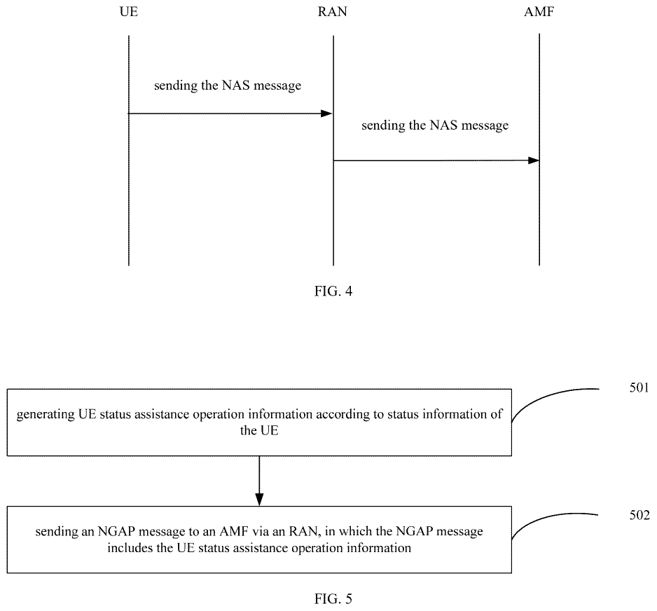

FIG. 3 is a flow chart illustrating a method for a UE status assistance operation according to another embodiment of the present disclosure. The method is performed by a UE. As shown in FIG. 3, the method may include the following steps.

In step 301, UE status assistance operation information is generated according to status information of the UE.

In step 302, an NAS message is sent to an AMF via an RAN, in which the NAS message includes the UE status assistance operation information.

In an embodiment of the present disclosure, the UE may generate the UE status assistance operation information according to the status information of the UE. For example, the UE may send the NAS message to the AMF via the RAN, in which the NAS message includes the UE status assistance operation information.

In an embodiment of the present disclosure, the status information of the UE includes at least one of: a battery level; a battery life; a powered mode; a temperature status; an overheating status; or a load status.

For example, in an embodiment of the present disclosure, the UE may generate the UE status assistance operation information according to the battery level of the UE.

For example, in an embodiment of the present disclosure, FIG. 4 is an interactive schematic diagram illustrating a method for a UE status assistance operation according to another embodiment of the present disclosure. For example, the UE may generate the UE status assistance operation information according to the status information of the UE. The UE may send the NAS message to the AMF via the RAN, in which the NAS message includes the UE status assistance operation information. For example, the UE may send the NAS message to the RAN, and the RAN may forward the NAS message to the AMF.

In summary, in the embodiments of the present disclosure, the UE status assistance operation information is generated according to the status information of the UE; and the NAS message is sent to the AMF via the RAN, in which the NAS message includes the UE status assistance operation information. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating a policy-associated rule. Embodiments of the present disclosure specifically describe a solution for sending the UE status assistance operation information via the NAS message. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 5 is a flow chart illustrating a method for a UE status assistance operation according to another embodiment of the present disclosure. The method is performed by a UE. As shown in FIG. 5, the method may include the following steps.

In step 501, UE status assistance operation information is generated according to status information of the UE.

In step 502, an NGAP message is sent to an AMF via an RAN, in which the NGAP message includes the UE status assistance operation information.

In an embodiment of the present disclosure, the UE may generate the UE status assistance operation information according to the status information of the UE. For example, the UE may send the NGAP message to the AMF via the RAN, in which the NGAP message includes the UE status assistance operation information.

In an embodiment of the present disclosure, the status information of the UE includes at least one of: a battery level; a battery life; a powered mode; a temperature status; an overheating status; or a load status.

For example, in an embodiment of the present disclosure, the UE may generate the UE status assistance operation information according to the powered mode of the UE.

For example, in an embodiment of the present disclosure, FIG. 6 is an interactive schematic diagram illustrating a method for a UE status assistance operation according to another embodiment of the present disclosure. For example, the UE may generate the UE status assistance operation information according to the status information of the UE. The UE may send the NGAP message to the AMF via the RAN, in which the NGAP message includes the UE status assistance operation information. For example, the UE may send a radio resource control (RRC) message to the RAN, the RAN may convert the RRC message into the NGAP message, and the RAN may send the NGAP message to the AMF.

In summary, in the embodiments of the present disclosure, the UE status assistance operation information is generated according to the status information of the UE; and the NGAP message is sent to the AMF via the RAN, in which the NGAP message includes the UE status assistance operation information. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating a policy-associated rule. Embodiments of the present disclosure specifically describe a solution for sending the UE status assistance operation information via the NGAP message. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

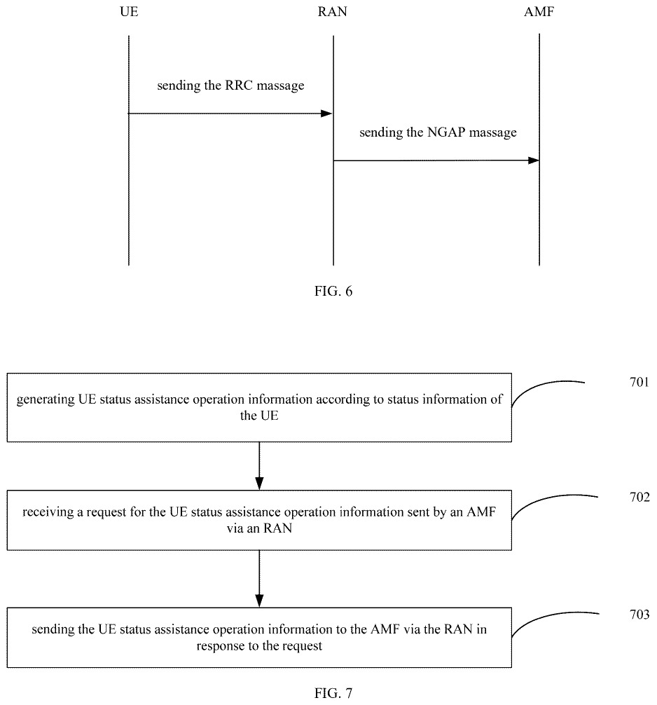

FIG. 7 is a flow chart illustrating a method for a UE status assistance operation according to another embodiment of the present disclosure. The method is performed by a UE. As shown in FIG. 7, the method may include the following steps.

In step 701, UE status assistance operation information is generated according to status information of the UE.

In step 702, a request for the UE status assistance operation information sent by an AMF via an RAN is received.

In step 703, the UE status assistance operation information is sent to the AMF via the RAN in response to the request.

In an embodiment of the present disclosure, the UE may generate the UE status assistance operation information according to the status information of the UE. The UE may receive the request for the UE status assistance operation information sent by the AMF via the RAN. The UE may send the UE status assistance operation information to the AMF via the RAN in response to the request.

In an embodiment of the present disclosure, the status information of the UE includes at least one of: a battery level; a battery life; a powered mode; a temperature status; an overheating status; or a load status.

For example, in an embodiment of the present disclosure, the UE may generate the UE status assistance operation information according to the temperature status of the UE.

Further, in an embodiment of the present disclosure, in a case where the AMF requires the UE status assistance operation information to be able to arrange/coordinate an XRM service or an XRM service group, the AMF may send a request message of the UE status assistance operation information to a next generation radio access network (NG-RAN). This process is typically used (e.g. as part of 5GMM context) during a registration process or in a case where the AMF does not receive the UE status assistance operation information or an XRM service indicator.

Further, in an embodiment of the present disclosure, the UE may receive the request for the UE status assistance operation information sent by the AMF via the RAN. For example, the AMF may send the request for the UE status assistance operation information to the RAN. The RAN may send the request for the UE status assistance operation information to the UE. The UE may send the UE status assistance operation information to the RAN. The RAN sends the UE status assistance operation information to the AMF.

For example, in an embodiment of the present disclosure, the AMF may send an NAS message to the RAN, in which the NAS message includes the request for the UE status assistance operation information. The RAN may send the NAS message to the UE. The UE may send the NAS message to the RAN. The NAS message includes the UE status assistance operation information. The RAN sends the NAS message to the AMF.

For example, in an embodiment of the present disclosure, the AMF may send the NAS message to the RAN, in which the NAS message includes the request for the UE status assistance operation information. The RAN may convert an NGAP message into the NAS message and send the NAS message to the UE. The UE may send the NAS message to the RAN. The NAS message includes the UE status assistance operation information. The RAN may convert the NAS message into the NGAP message and send the NGAP message to the AMF.

Further, in an embodiment of the present disclosure, FIG. 8 is an interactive schematic diagram illustrating a method for a UE status assistance operation according to another embodiment of the present disclosure. In a first step, the AMF may send an N2 message to the NG-RAN. The N2 message includes the UE status assistance operation information. The AMF may indicate whether the AMF wants to receive a UE status assistance operation indication or information and/or the XRM service/a group indicator. The AMF may include the UE status assistance operation indication or information it previously received from the NG-RAN.

In a second step, after receiving the request for the UE status assistance operation information, in a case where the NG-RAN has not received the UE status assistance operation information from the UE or the AMF before receiving the request for the UE status assistance operation information sent by the AMF, the NG-RAN requests the UE to upload the UE status assistance operation information, that is, the NG-RAN may send an RRC message to the UE, in which the RRC message includes a query for the UE status assistance operation information.

In a third step, the UE may send the RRC message to the RAN. The RRC message includes the UE status assistance operation information.

In a fourth step, the NG-RAN stores the UE status assistance operation information. The NG-RAN may check whether the UE status assistance operation information is compatible with an operator policy (e.g. a network configuration) to support the XRM service. In order to determine a suitable UE status assistance operation information response, an operator may configure the NG-RAN to check whether the UE supports certain capabilities required for the XRM service. In a shared network, the NG-RAN reserves a separate configuration for each public land mobile network (PLMN).

Further, in an embodiment of the present disclosure, the NG-RAN sends the N2 message to the AMF, and the N2 message includes the UE status assistance operation information response, that is, sending the UE status assistance operation information and/or an XRM service (or a service group) indication to indicate whether status information included in the UE status assistance operation information (or a UE capability) as part of the capability is compatible with the operator policy to support the XRM service (e.g., suitable for power consumption requirements).

Further, in an embodiment of the present disclosure, the AMF may store the UE status assistance operation information received and/or the XRM service (or the service group) indicator (e.g., in the 5GMM context). The UE status assistance operation information may be configured as an input for arranging the XRM service.

In a fifth step, the NG-RAN sends the N2 message to the AMF, in which the N2 message includes the UE status assistance operation information. In a case where the NG-RAN requests the UE status assistance operation information from the UE, the NG-RAN further sends the UE status assistance operation information to the AMF. The AMF stores a UE status assistance operation information indication or information, and/or the XRM service (or a service group) indicator.

In summary, in the embodiments of the present disclosure, the UE status assistance operation information is generated according to the status information of the UE; the request for the UE status assistance operation information sent by the AMF via the RAN is received; and the UE status assistance operation information is sent to the AMF via the RAN in response to the request. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating the policy-associated rule. Embodiments of the present disclosure specifically describe a solution for sending the UE status assistance operation information in response to the request for the UE status assistance operation information. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

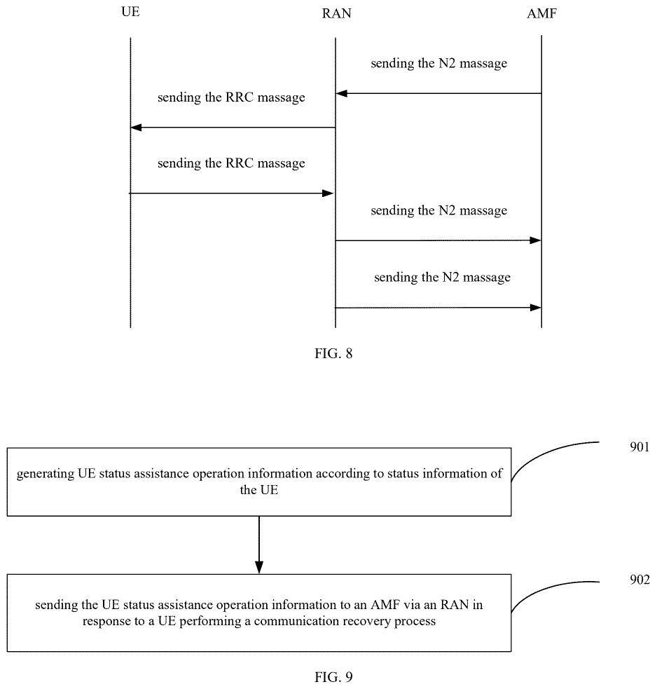

FIG. 9 is a flow chart illustrating a method for a UE status assistance operation according to another embodiment of the present disclosure. The method is performed by a UE. As shown in FIG. 9, the method may include the following steps.

In step 901, UE status assistance operation information is generated according to status information of the UE.

In step 902, the UE status assistance operation information is sent to an AMF via an RAN in response to a UE performing a communication recovery process.

In an embodiment of the present disclosure, the UE may generate the UE status assistance operation information according to status information of the UE. The UE may send the UE status assistance operation information to the AMF via the RAN in response to the UE performing the communication recovery process.

In an embodiment of the present disclosure, the status information of the UE includes at least one of: a battery level; a battery life; a powered mode; a temperature status; an overheating status; or a load status.

For example, in an embodiment of the present disclosure, the UE may generate the UE status assistance operation information according to the load status of the UE.

Further, in an embodiment of the present disclosure, the UE may send the UE status assistance operation information to the AMF via the RAN in response to the UE performing the communication recovery process. For example, the UE may use a communication resume procedure to perform a transition from an RRC inactive status to an RRC connected status.

For example, in an embodiment of the present disclosure, the UE may exchange information with the RAN using an NAS message, and the RAN may exchange the information with the AMF using the NAS message. The UE may exchange the information with the RAN using the NAS message, and the RAN may exchange the information with the AMF using an NGAP message.

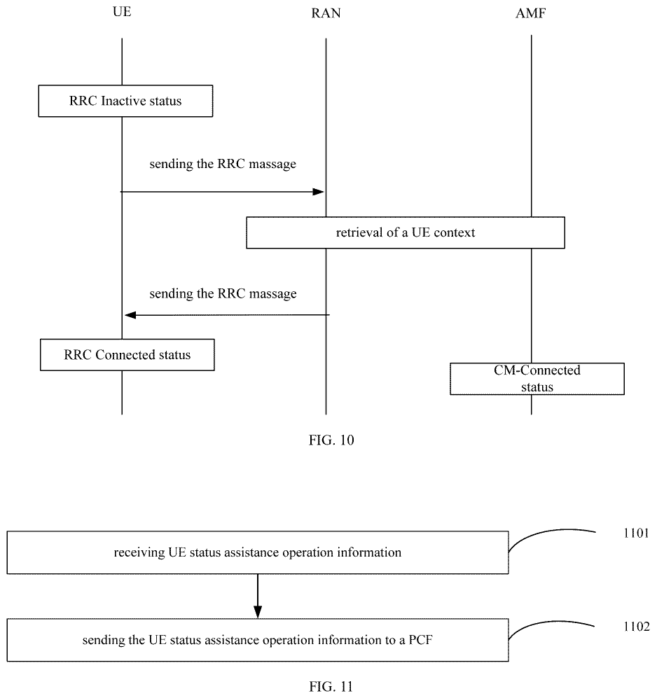

Further, in an embodiment of the present disclosure, FIG. 10 is an interactive schematic diagram illustrating a method for a UE status assistance operation according to another embodiment of the present disclosure. In a first step, the UE may send an RRC message (a resume ID) to an NG-RAN. The UE may initiate the transition from the RRC inactive status to the RRC connected status. The UE may provide the resume ID required for the NG-RAN to access a context stored by the UE. The UE may provide a UE status assistance operation indication or information required by the NG-RAN, which may be configured to check with an operator policy or a network configuration (such as an XRM service/a group support).

In a second step, the NG-RAN stores the UE status assistance operation information received. The NG-RAN may perform retrieval of a UE context. The retrieval of the UE context is performed in a case where a UE context associated with the UE attempting to restore its connection is not locally available at the NG-RAN accessed.

In a third step, [conditional] an N2 path switching procedure is performed. In a case where the NG-RAN accessed may retrieve the UE context, an NG-RAN node accessed starts the N2 path switching procedure. In a case where the AMF requests an N2 notification from the NG-RAN, the NG-RAN sends a UE notification message to report that the UE is in the RRC connected status. In a case where a notification of the UE status assistance operation information is requested, the NG-RAN provides the UE status assistance operation information received to the AMF.

In a fourth step, the NG-RAN sends the RRC message to the UE. The RRC message is configured by the NG-RAN to confirm to the UE that the UE has entered the RRC connected status.

In summary, in the embodiments of the present disclosure, the UE status assistance operation information is generated according to the status information of the UE; and the UE status assistance operation information is sent to the AMF via the RAN in response to the UE performing the communication recovery process. In the embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating the policy-associated rule. Embodiments of the present disclosure specifically describe a solution for sending the UE status assistance operation information in response to the UE performing the communication recovery process. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 11 is a flow chart illustrating a method for a UE status assistance operation according to another embodiment of the present disclosure. The method is performed by an AMF. As shown in FIG. 11, the method may include the following steps.

In step 1101, UE status assistance operation information is received.

In step 1102, the UE status assistance operation information is sent to a PCF.

In an embodiment of the present disclosure, the UE status assistance operation information may be, for example, sent by an RAN to the AMF, in which the RAN may, for example, receive the UE status assistance operation information sent by a UE, and the UE status assistance operation information may, for example, be generated by the UE according to status information of the UE.

In an embodiment of the present disclosure, the method further includes: receiving a policy-associated rule sent by the PCF, in which the policy-associated rule is generated by the PCF according to the UE status assistance operation information, and the policy-associated rule includes at least one of a QoS rule or a UE policy rule; and sending the policy-associated rule to the UE.

In an embodiment of the present disclosure, in a case where the AMF sends the policy-associated rule to the UE, for example, the AMF may send the policy-associated rule to the UE via the RAN, thereby reducing a situation that a network element of a core network directly sends the policy-associated rule to the UE.

Further, in an embodiment of the present disclosure, the policy-associated rule includes the QoS rule, and receiving the policy-associated rule sent by the PCF includes: receiving the QoS rule sent by the PCF via an SMF, in which the QoS rule is generated by the SMF converting a PCC rule sent by the PCF.

Further, in an embodiment of the present disclosure, the UE status assistance operation information includes at least one of: a UE status assistance operation mode; a UE status assistance operation mode indication; threshold information; a UE status assistance operation mode function; priority information; or importance level information.

Further, in an embodiment of the present disclosure, the UE status assistance operation mode is applied for matching traffic and an associated parameter.

Further, in an embodiment of the present disclosure, the UE status assistance operation mode indication indicates an autonomous operation or a UE-assistance operation in a case where the UE status assistance operation mode is a mode set, in which the mode set includes at least one of a load balancing mode, a power consumption balancing mode, or a PDU set-based QoS handling mode.

Further, in an embodiment of the present disclosure, the threshold information includes at least one of: a maximum RTT; a maximum packet loss rate; a GFBR; or an AMBR.

Further, in an embodiment of the present disclosure, the UE status assistance operation mode function is configured to determine whether to apply the mode set for the matching traffic, in which the mode set includes at least one of the load balancing mode, the power consumption balancing mode, or the PDU set-based QoS handling mode.

Further, in an embodiment of the present disclosure, the priority information is configured to determine a priority of whether to apply a QoS for the matching traffic, in which the priority is greater than a priority threshold.

Further, in an embodiment of the present disclosure, the importance level information is configured to determine an importance level of whether to apply the QoS for the matching traffic, in which the importance level is greater than an importance level threshold.

Further, in an embodiment of the present disclosure, receiving the UE status assistance operation information includes: receiving an NAS message sent by the UE via the RAN, in which the NAS message includes the UE status assistance operation information.

Further, in an embodiment of the present disclosure, receiving the UE status assistance operation information includes: receiving an NGAP message sent by the UE via the RAN, in which the NGAP message includes the UE status assistance operation information, and the NGAP message is generated by the RAN converting an RRC message sent by the UE.

Further, in an embodiment of the present disclosure, receiving the UE status assistance operation information includes: sending a request for the UE status assistance operation information to the UE via the RAN; and receiving the UE status assistance operation information sent by the UE via the RAN in response to the request.

Further, in an embodiment of the present disclosure, receiving the UE status assistance operation information includes: receiving the UE status assistance operation information sent by the UE via the RAN in response to the UE performing a communication recovery process.

Further, in an embodiment of the present disclosure, sending the UE status assistance operation information to the PCF includes: receiving a subscription request sent by the PCF for the UE status assistance operation information; and sending the UE status assistance operation information to the PCF in response to the subscription request and in a case where a reporting condition is satisfied.

For example, in an embodiment of the present disclosure, the reporting condition includes at least one of: reporting in a case of receiving the UE status assistance operation information; periodical reporting; reporting in a case where at least one reporting threshold of relevant status information is reached; or reporting in a case of receiving a reporting indication.

Further, in an embodiment of the present disclosure, sending the UE status assistance operation information to the PCF includes: determining to send the UE status assistance operation information to the PCF according to subscription information or an operator policy.

In summary, in the embodiments of the present disclosure, the UE status assistance operation information is received; and the UE status assistance operation information is sent to the PCF. In the embodiments of the present disclosure, it is not necessary to directly send the status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

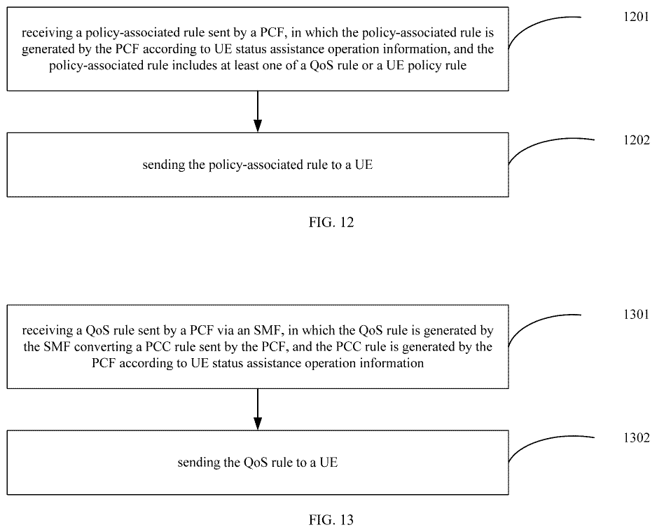

FIG. 12 is a flow chart illustrating a method for a UE status assistance operation according to another embodiment of the present disclosure. The method is performed by an AMF. As shown in FIG. 12, the method may include the following steps.

In step 1201, a policy-associated rule sent by a PCF is received, in which the policy-associated rule is generated by the PCF according to UE status assistance operation information, and the policy-associated rule includes at least one of a QoS rule or a UE policy rule.

In step 1202, the policy-associated rule is sent to a UE.

In an embodiment of the present disclosure, in a case where the AMF sends the policy-associated rule to the UE, for example, may send the policy-associated rule to the UE via an RAN, a situation that a network element of a core network directly sends the policy-associated rule to the UE is reduced. That is, the AMF sends the policy-associated rule to the RAN. In a case of receiving the policy-associated rule, the RAN may forward the policy-associated rule to the UE.

In summary, in the embodiments of the present disclosure, the policy-associated rule sent by the PCF is received, in which the policy-associated rule is generated by the PCF according to the UE status assistance operation information, and the policy-associated rule includes at least one of the QoS rule or the UE policy rule; and the policy-associated rule is sent to the UE. In the embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for receiving and forwarding the policy-associated rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 13 is a flow chart illustrating a method for a UE status assistance operation according to another embodiment of the present disclosure. The method is performed by an AMF. As shown in FIG. 13, the method may include the following steps.

In step 1301, a QoS rule sent by a PCF via an SMF is received, in which the QoS rule is generated by the SMF converting a PCC rule sent by the PCF, and the PCC rule is generated by the PCF according to UE status assistance operation information.

In step 1302, the QoS rule is sent to a UE.

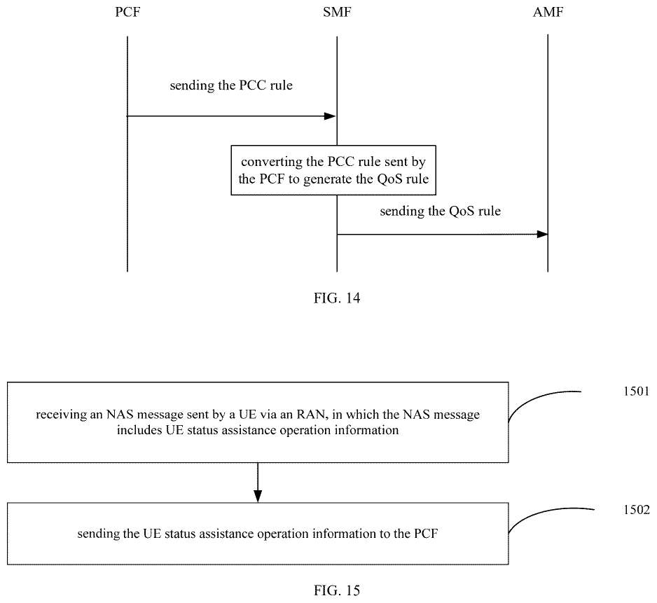

Further, in an embodiment of the present disclosure, FIG. 14 is an interactive schematic diagram illustrating a method for a UE status assistance operation according to another embodiment of the present disclosure. The PCF may send the PCC rule to the SMF. The SMF may convert the PCC rule sent by the PCF to generate the QoS rule. The SMF may send the QoS rule to the AMF. The AMF may send the QoS rule to the UE.

In summary, in the embodiments of the present disclosure, the QoS rule sent by the PCF via the SMF is received, in which the QoS rule is generated by the SMF converting the PCC rule sent by the PCF, and the PCC rule is generated by the PCF according to the UE status assistance operation information; and the QoS rule is sent to the UE. In the embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for receiving and forwarding the QoS rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 15 is a flow chart illustrating a method for a UE status assistance operation according to another embodiment of the present disclosure. The method is performed by an AMF. As shown in FIG. 15, the method may include the following steps.

In step 1501, an NAS message sent by a UE via an RAN is received, in which the NAS message includes UE status assistance operation information.

In step 1502, the UE status assistance operation information is sent to the PCF.

In summary, in embodiments of the present disclosure, the NAS message sent by the UE via the RAN is received, in which the NAS message includes the UE status assistance operation information; and the UE status assistance operation information is sent to the PCF. In embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information via the NAS message. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

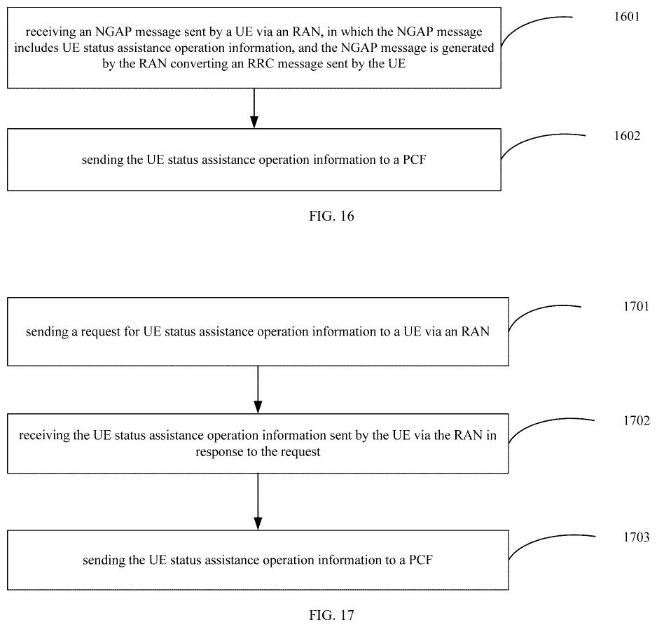

FIG. 16 is a flow chart illustrating a method for a UE status assistance operation according to another embodiment of the present disclosure. The method is performed by an AMF. As shown in FIG. 16, the method may include the following steps.

In step 1601, an NGAP message sent by a UE via an RAN is received, in which the NGAP message includes UE status assistance operation information, and the NGAP message is generated by the RAN converting an RRC message sent by the UE.

In step 1602, the UE status assistance operation information is sent to a PCF.

In summary, in embodiments of the present disclosure, the NGAP message sent by the UE via the RAN is received, in which the NGAP message includes the UE status assistance operation information, and the NGAP message is generated by the RAN converting the RRC message sent by the UE; and the UE status assistance operation information is sent to the PCF. In embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information via the NGAP message. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 17 is a flow chart illustrating a method for a UE status assistance operation according to another embodiment of the present disclosure. The method is performed by an AMF. As shown in FIG. 17, the method may include the following steps.

In step 1701, a request for UE status assistance operation information is sent to a UE via an RAN.

In step 1702, the UE status assistance operation information sent by the UE via the RAN in response to the request is received.

In step 1703, the UE status assistance operation information is sent to a PCF.

In summary, in the embodiments of the present disclosure, the request for the UE status assistance operation information is sent to the UE via the RAN; the UE status assistance operation information sent by the UE via the RAN in response to the request is received; and the UE status assistance operation information is sent to the PCF. In the embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information in response to the request for the UE status assistance operation information. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

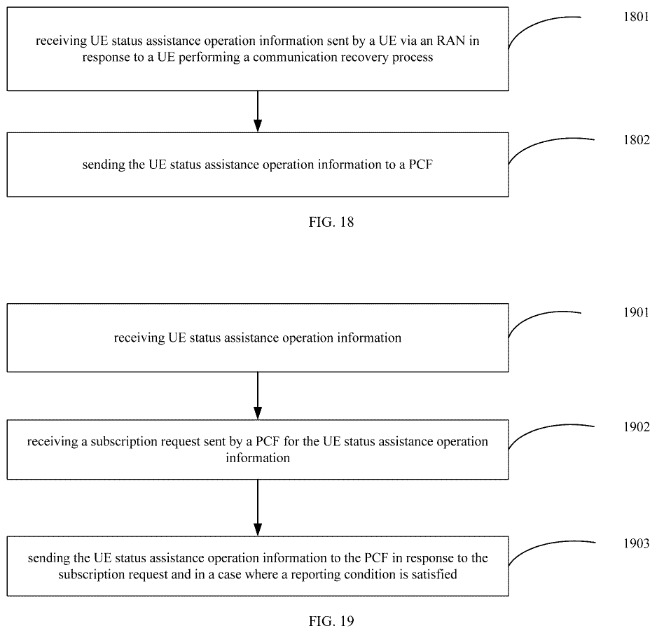

FIG. 18 is a flow chart illustrating a method for a UE status assistance operation according to another embodiment of the present disclosure. The method is performed by an AMF. As shown in FIG. 18, the method may include the following steps.

In step 1801, UE status assistance operation information sent by a UE via an RAN is received in response to a UE performing a communication recovery process.

In step 1802, the UE status assistance operation information is sent to a PCF.

In summary, in the embodiments of the present disclosure, the UE status assistance operation information sent by the UE via the RAN is received in response to the UE performing the communication recovery process; and the UE status assistance operation information is sent to the PCF. In embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information in response to the UE performing the communication recovery process. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 19 is a flow chart illustrating a method for a UE status assistance operation according to another embodiment of the present disclosure. The method is performed by an AMF. As shown in FIG. 19, the method may include the following steps.

In step 1901, UE status assistance operation information is received.

In step 1902, a subscription request sent by a PCF for the UE status assistance operation information is received.

In step 1903, the UE status assistance operation information is sent to the PCF in response to the subscription request and in a case where a reporting condition is satisfied.

In an embodiment of the present disclosure, the reporting condition includes at least one of: reporting in a case of receiving the UE status assistance operation information; periodical reporting; reporting in a case where at least one reporting threshold of relevant status information is reached; or reporting in a case of receiving a reporting indication.

In summary, in the embodiments of the present disclosure, the UE status assistance operation information is received; the subscription request sent by the PCF for the UE status assistance operation information is received; and the UE status assistance operation information is sent to the PCF in response to the subscription request and in a case where the reporting condition is satisfied. In the embodiments of the present disclosure, it is not necessary to directly send status information of the UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information to the PCF in response to the subscription request and in a case where the reporting condition is satisfied. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

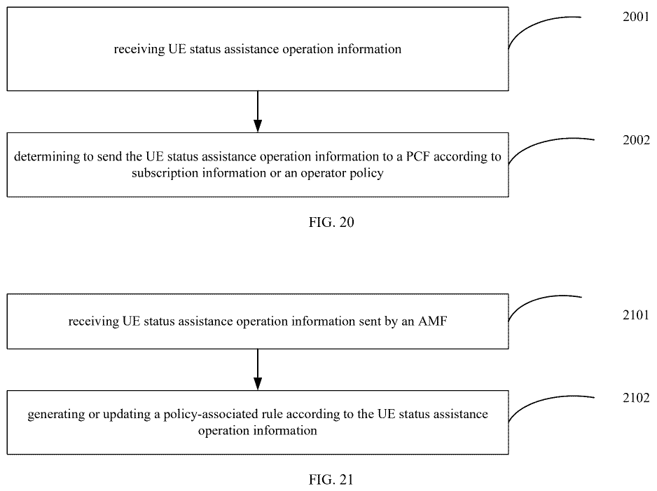

FIG. 20 is a flow chart illustrating a method for a UE status assistance operation according to another embodiment of the present disclosure. The method is performed by an AMF. As shown in FIG. 20, the method may include the following steps.

In step 2001, UE status assistance operation information is received.

In step 2002, it is determined to send the UE status assistance operation information to a PCF according to subscription information or an operator policy.

In summary, in the embodiments of the present disclosure, the UE status assistance operation information is received; and it is determined to send the UE status assistance operation information to the PCF according to the subscription information or the operator policy. In the embodiments of the present disclosure, it is not necessary to directly send status information of a UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. Embodiments of the present disclosure specifically describe a solution for sending the UE status assistance operation information to the PCF according to the subscription information or the operator policy. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 21 is a flow chart illustrating a method for a UE status assistance operation according to another embodiment of the present disclosure. The method is performed by a PCF. As shown in FIG. 21, the method may include the following steps.

In step 2101, UE status assistance operation information sent by an AMF is received.

In step 2102, a policy-associated rule is generated or updated according to the UE status assistance operation information.

In an embodiment of the present disclosure, generating or updating the policy-associated rule includes at least one of: updating a QoS parameter of a service session and/or a service data flow of a UE; determining whether to perform PDU set-based QoS handling; or determining whether to select a different QoS profile and perform a different QoS level according to a parameter feature of a PDU set and/or a PDU set group, in which the parameter feature includes at least one of priority, importance, or dependency.

For example, in an embodiment of the present disclosure, the QoS parameter includes at least one of: an MFBR and/or a GFBR of an uplink GBR data flow; an AMBR of an uplink non-GBR data flow; an MFBR and/or a GFBR of a downlink GBR data flow; an AMBR of a downlink non-GBR data flow; a maximum RTT; or a maximum packet loss rate.

For example, in an embodiment of the present disclosure, the method further includes: sending the policy-associated rule to the AMF.

For example, in an embodiment of the present disclosure, the policy-associated rule includes a PCC rule, and sending the policy-associated rule to the AMF includes: sending the PCC rule to an SMF, in which the PCC rule is used by the SMF to convert the PCC rule into a QoS rule, and send the QoS rule to the AMF.

In summary, in the embodiments of the present disclosure, the UE status assistance operation information is received; and the policy-associated rule is generated or updated according to the UE status assistance operation information. In the embodiments of the present disclosure, it is not necessary to directly receive status information of the UE, which may avoid a situation of the exposure of the status information of the UE. Moreover, the UE status assistance operation information may be received, that is, a policy decision may be made according to the requirements of the UE, thereby improving the accuracy of generating the policy-associated rule. The present disclosure provides a processing method for a case of “a UE status assistance operation” to receive the UE status assistance operation information, which may provide a UE status assistance operation mechanism, and may balance the power consumption and experience quality while avoiding the exposure of the status information of the UE.

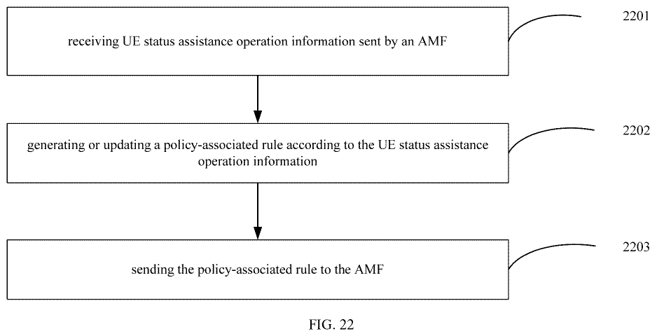

FIG. 22 is a flow chart illustrating a method for a UE status assistance operation according to another embodiment of the present disclosure. The method is performed by a PCF. As shown in FIG. 22, the method may include the following steps.

In step 2201, UE status assistance operation information sent by an AMF is received.

In step 2202, a policy-associated rule is generated or updated according to the UE status assistance operation information.

In step 2203, the policy-associated rule is sent to the AMF.

For example, in an embodiment of the present disclosure, the policy-associated rule includes a PCC rule, and sending the policy-associated rule to the AMF includes: sending the PCC rule to an SMF, in which the PCC rule is used by the SMF to convert the PCC rule into a QoS rule, and send the QoS rule to the AMF.

In summary, in the embodiments of the present disclosure, the UE status assistance operation information sent by the AMF is received, in which the UE status assistance operation information is generated according to status information of a UE; the policy-associated rule is generated or updated according to the UE status assistance operation information; and the policy-associated rule is sent to the AMF. In the embodiments of the present disclosure, it is not necessary to directly receive the status information of the UE, which may avoid a situation of the exposure of the status information of the UE. Moreover, the UE status assistance operation information may be received, that is, a policy decision may be made according to the requirements of the UE, thereby improving the accuracy of generating the policy-associated rule. Embodiments of the present disclosure specifically describe a solution for sending the policy-associated rule to the AMF. The present disclosure provides a processing method for a case of “a UE status assistance operation” to receive the UE status assistance operation information, which may provide a UE status assistance operation mechanism, and may balance the power consumption and experience quality while avoiding the exposure of the status information of the UE.

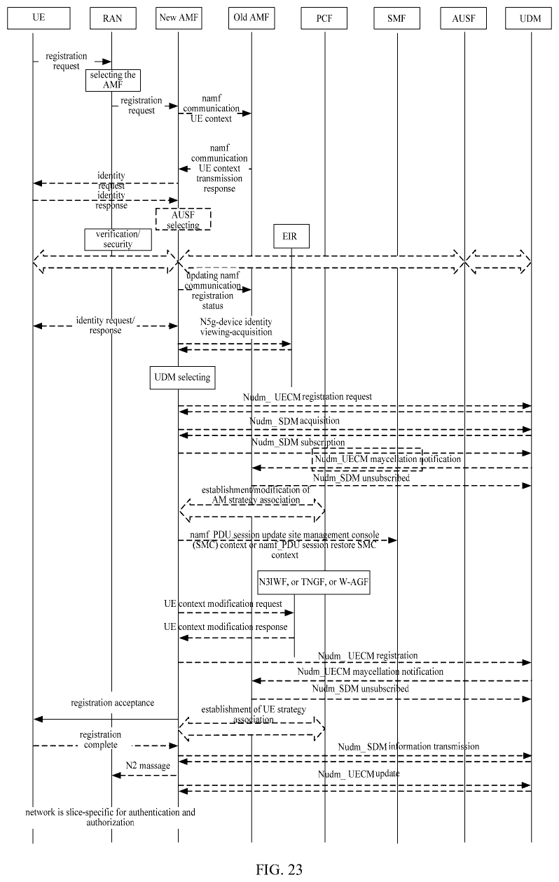

FIG. 23 is an interactive schematic diagram illustrating a method for a UE status assistance operation according to another embodiment of the present disclosure. As shown in FIG. 23, the method includes the following steps.

In a first step, a UE sends a registration request to an RAN, in which the registration request carries a UE MM core network capability, including capability support of “UE status assistance operation information”. A message sent by the UE to the RAN includes an AN parameter, the registration request (a registration type, a subscription concealed identifier (SUCI) or a 5G-globally unique temporary identifier (GUTI) or a permanent equipment identifier (PEI)), [a TAI last accessed (if available)], a security parameter, [network slice selection assistance information (NSSAI) requested], [a mapping of the NSSAI requested], [an NSSAI indication default configured], [UE radio communication capability update], [the UE MM core network capability] . . . . In a case where the UE supports a UE status assistance operation, the UE status assistance operation information is included in the UE MM core network capability. (In order to ensure that UE MM core network capability information stored in an AMF is up-to-date, the UE shall send the UE MM core network capability information to the AMF during initial registration and mobility registration update procedures in an NAS message.)

In a second step, the RAN selects the AMF.

In a third step, the RAN sends the registration request to a new AMF, in which the registration request includes information of the registration request in the first step. The AMF stores the UE status assistance operation information. Specifically, the AMF stores the UE status assistance operation information and the UE MM core network capability into a UE context. In a case where the UE provides a registration signaling to the UE MM core network capability, any UE MM core network capability received by the AMF from an old AMF/mobility management entity (MME) are replaced.

In a fourth step, the new AMF requests the old AMF to send an namf communication UE context to the new AMF.

In a fifth step, the old AMF sends an namf communication UE context transmission response to the new AMF.

In a sixth step, the new AMF sends an identity request to the UE.

In a seventh step, the UE sends an identity response to the new AMF.

In an eighth step, the new AMF selects an authentication server function (AUSF).

In a ninth step, verification/security is performed.

In a tenth step, the new AMF requests the old AMF to update an namf communication registration status.

In an eleventh step, the identity request/response between the new AMF and the UE is performed.

In a twelfth step, N5g-device identity viewing-acquisition is performed between the new AMF and an equipment identification register (EIR).

In a thirteenth step, the new AMF selects a unified data management (UDM) function.

In a fourteenth step a, the new AMF sends an Nudm_UEContextManagement (UECM) service registration request to the UDM.

In a fourteenth step b, the new AMF obtains an Nudm_security device manager (SDM).

In a fourteenth step c, the new AMF sends an Nudm_SDM subscription to the UDM.

In a fourteenth step d, the UDM sends an Nudm_UECM maycellation notification to the old AMF.

In a fourteenth step e, the old AMF sends an Nudm_SDM unsubscribed to the UDM.

In a fifteenth step, the new AMF selects a PCF.

In a sixteenth step, an AM strategy association between the new AMF and the PCF is established/modified.

In a seventeenth step, the new AMF sends an namf_PDU session update site management console (SMC) context or an namf_PDU session restore SMC context to the SMF.

In an eighteenth step, the new AMF sends a UE context modification request to a non-3GPP interworking function (N3IWF), or a trusted non-3GPP gateway function (TNGF), or a wireline access gateway function (W-AGF).

In a nineteenth step, the N3IWF, or the TNGF, or the W-AGF sends a UE context modification response to the new AMF.

In a twentieth step a, the new AMF sends an Nudm_UECM registration to the UDM.

In a twentieth step b, the UDM sends an Nudm_UECM maycellation notification to the old AMF.

In a twentieth step c, the old AMF sends an Nudm_SDM unsubscribed to the UDM.

In a twenty-first step a, the new AMF sends a registration acceptance to the UE.

In a twenty-first step b, a UE strategy association is established, in which the new AMF sends an Npcf_UE policy control creation request to the PCF. The PCF sends an Npcf_UE policy control creation response to the new AMF.

In a twenty-second step, a registration is completed.

In a twenty-third step, Nudm_SDM information transmission is performed between the new AMF and the UDM.

In a twenty-third step a, the new AMF sends an N2 message to the RAN.

In a twenty-fourth step, an Nudm_UECM is updated between the new AMF and the UDM.

In a twenty-fifth step, a network is slice-specific for authentication and authorization.

In an embodiment of the present disclosure, the PCF triggers a UE configuration update procedure defined in section 4.2.4.3, and sends a UE-associated policy updated to the AMF and the UE. Alternatively, in a case where an SM association PCF is subscribed to the AMF, the PCF triggers a session modification procedure and sends a session-associated policy updated to the SMF (a UPF), the RAN and the UE.

In an embodiment of the present disclosure, a specific QoS update may be: the PCF, according to the UE status assistance operation information, for example, in a case where a current UE temperature is too high to meet a current bandwidth requirement, reduces a session-AMBR of an XRM service, and specifically performs the following QoS update.

In a case where the UPF receives a session-AMBR value from the SMF, an upload (UL) session-AMBR and/or a download (DL) session-AMBR updated by the PCF shall be enforced by the UPF.

In a case where the UE receives a session-AMBR, the UE shall perform a PDU session-based UL rate limiting on non-GBR traffic using the session-AMBR.

(R)AN shall enforce the UE-AMBR in UL and DL of each UE for a non-GBR QoS flow.

In a case where the PCF updates the MFBR, the UPF executes a downlink MFBR updated for a GBR QoS flow. Regarding the GBR QoS flow, the (R)AN performs uplink and downlink MFBR updated.

In a case where the PCF updates a UE-Slice-AMBR, the RAN shall, in a case of feasible, apply the UE-Slice-MBR to all PDU sessions, which correspond to service network slice selection assistance information (S-NSSAI) and have an active user plane, of the UE in a case where the RAN receives the UE-Slice-MBR updated. (In a case where the RAN is supported to receive the NSSAI of the UE-Slice-MBR from the AMF for the UE, the RAN shall apply the UE-Slice-MBR to all the PDU sessions, which correspond to the S-NSSAI and have the active user plane, of the UE, in a case of feasible.) 1) Whenever a request for establishment/modification of the GBR QoS flow is received, an RAN admission control shall ensure that a sum of GFBR values of a GBR QoS flow admitted does not exceed the UE-Slice-MBR. In a case where the QoS flow may not be admitted, the RAN shall reject the establishment/modification of the QoS flow. 2) The RAN shall ensure that aggregate bit rates of all GBR and the non-GBR QoS flow belonging to those PDU sessions do not exceed the UE-Slice-MBR, while always guaranteeing the GFBR of each GBR QoS flow of those PDU sessions.

Further, in an embodiment of the present disclosure, in the above steps, the UE may exchange information with the RAN via the NAS message, and the RAN may exchange information with the AMF via the NAS message. Alternatively, the UE may exchange information with the RAN via an RRC message, and the RAN may exchange information with the AMF via an NGAP message.

The second step above further includes: an NG-RAN stores the UE status assistance operation information received. According to an AMF selection policy, the AMF is selected to perform a UE registration procedure.

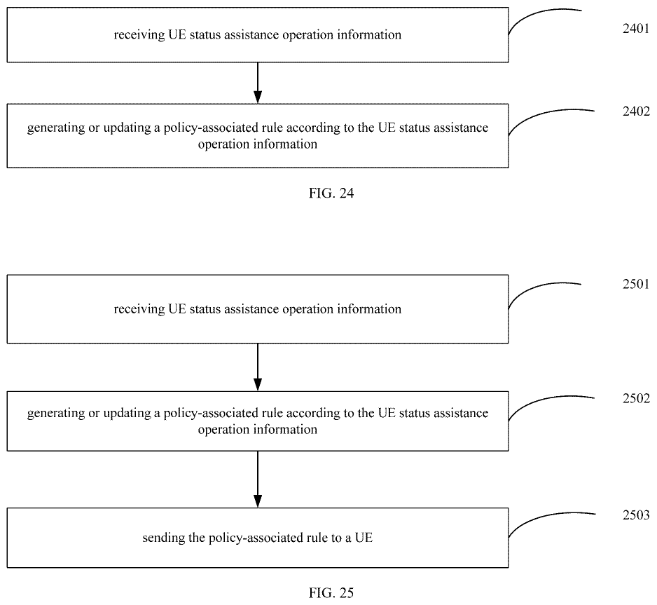

FIG. 24 is a flow chart illustrating a method for a UE status assistance operation according to another embodiment of the present disclosure. The method is performed by a core network. As shown in FIG. 24, the method may include the following steps.

In step 2401, UE status assistance operation information is received.

In step 2402, a policy-associated rule is generated or updated according to the UE status assistance operation information.

Further, in an embodiment of the present disclosure, receiving the UE status assistance operation information includes: an AMF receiving the UE status assistance operation information sent by an RAN.

Further, in an embodiment of the present disclosure, generating or updating the policy-associated rule according to the UE status assistance operation information includes: the AMF receiving the UE status assistance operation information; the AMF sending the UE status assistance operation information to a PCF; the PCF receiving the UE status assistance operation information sent by the AMF; and the PCF generating or updating the policy-associated rule according to the UE status assistance operation information.

Further, in an embodiment of the present disclosure, the policy-associated rule includes a PCC rule, and the method further includes: the PCF sending the PCC rule to an SMF; and the SMF converting the PCC rule into a QoS rule and sending the QoS rule to the AMF.

Further, in an embodiment of the present disclosure, generating or updating the policy-associated rule includes at least one of: updating a QoS parameter of a service session and/or a service data flow of a UE; determining whether to perform PDU set-based QoS handling; or determining whether to select a different QoS profile and perform a different QoS level according to a parameter feature of a PDU set and/or a PDU set group, in which the parameter feature includes at least one of priority, importance, or dependency.

Further, in an embodiment of the present disclosure, the QoS parameter includes at least one of: an MFBR and/or a GFBR of an uplink GBR data flow; an AMBR of an uplink non-GBR data flow; an MFBR and/or a GFBR of a downlink GBR data flow; an AMBR of a downlink non-GBR data flow; a maximum RTT; or a maximum packet loss rate.

Further, in an embodiment of the present disclosure, after generating or updating the policy-associated rule, the method further includes: sending the policy-associated rule to the AMF.

For example, in an embodiment of the present disclosure, in a case where the core network sends the policy-associated rule to the UE, for example, the core network may send the policy-associated rule to the UE via the RAN, that is, the core network may send the policy-associated rule to the RAN, the RAN may receive the policy-associated rule and send the policy-associated rule to the UE.

In summary, in the embodiments of the present disclosure, the UE status assistance operation information is received; and the policy-associated rule is generated or updated according to the UE status assistance operation information. In the embodiments of the present disclosure, it is not necessary to receive status information of the UE, which may avoid a situation of the exposure of the status information of the UE. Moreover, the UE status assistance operation information may be received, such that the core network may make a policy decision according to the requirements of the UE, thereby improving the accuracy of generating the policy-associated rule. The present disclosure provides a processing method for a case of “a UE status assistance operation” to receive the UE status assistance operation information, which may provide a UE status assistance operation mechanism, and may balance the power consumption and experience quality while avoiding the exposure of the status information of the UE.

FIG. 25 is a flow chart illustrating a method for a UE status assistance operation according to another embodiment of the present disclosure. The method is performed by a core network. As shown in FIG. 25, the method may include the following steps.

In step 2501, UE status assistance operation information is received.

In step 2502, a policy-associated rule is generated or updated according to the UE status assistance operation information.

In step 2503, the policy-associated rule is sent to a UE.

In summary, in the embodiments of the present disclosure, the UE status assistance operation information is received; the policy-associated rule is generated or updated according to the UE status assistance operation information; and the policy-associated rule is sent to the UE. In the embodiments of the present disclosure, it is not necessary to receive status information of the UE, which may avoid a situation of the exposure of the status information of the UE. Moreover, the UE status assistance operation information may be received, such that the core network may make a policy decision according to the requirements of the UE, thereby improving the accuracy of generating the policy-associated rule. Embodiments of the present disclosure specifically describe a solution for sending the policy-associated rule to the UE. The present disclosure provides a processing method for a case of “a UE status assistance operation” to receive the UE status assistance operation information, which may provide a UE status assistance operation mechanism, and may balance the power consumption and experience quality while avoiding the exposure of the status information of the UE.

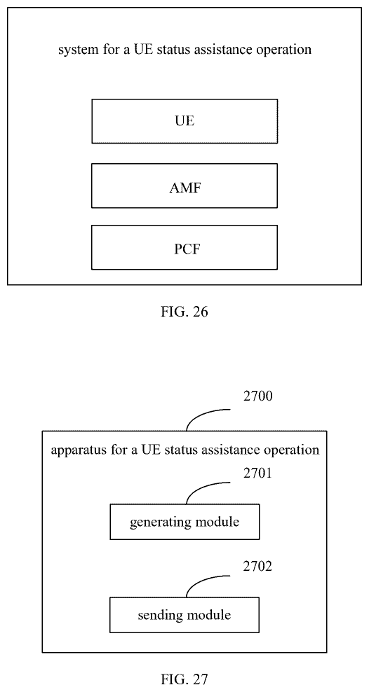

FIG. 26 is a schematic structural diagram illustrating a system for a UE status assistance operation according to an embodiment of the present disclosure. As shown in FIG. 26, the system includes: a UE configured to generate UE status assistance operation information according to status information of the UE; in which the UE is further configured to send the UE status assistance operation information to an AMF; the AMF is configured to receive the UE status assistance operation information sent by the UE; the AMF is further configured to send the UE status assistance operation information to a PCF; the PCF is configured to receive the UE status assistance operation information sent by the AMF; and the PCF is further configured to generate or update a policy-associated rule according to the UE status assistance operation information.

In summary, in the embodiments of the present disclosure, the UE is configured to generate the UE status assistance operation information according to the status information of the UE; the UE is further configured to send the UE status assistance operation information to the AMF; the AMF is configured to receive the UE status assistance operation information sent by the UE; the AMF is further configured to send the UE status assistance operation information to the PCF; the PCF is configured to receive the UE status assistance operation information sent by the AMF; and the PCF is further configured to generate or update the policy-associated rule according to the UE status assistance operation information. In the embodiments of the present disclosure, it is not necessary to directly send the status information of the UE to the AMF, which may avoid a situation of the exposure of the status information of the UE. Moreover, the UE status assistance operation information may be sent to the AMF, such that the PCF may make a policy decision according to the requirements of the UE, thereby improving the accuracy of generating the policy-associated rule. The present disclosure provides a processing method for a case of “a UE status assistance operation” to provide the UE status assistance operation information, which may provide a UE status assistance operation mechanism, and may balance the power consumption and experience quality while avoiding the exposure of the status information of the UE.

FIG. 27 is a schematic structural diagram illustrating an apparatus for a UE status assistance operation according to an embodiment of the present disclosure. As shown in FIG. 27, an apparatus 2700 may be applied to a UE, and may include: a generating module 2701 configured to generate UE status assistance operation information according to status information of the UE; and a sending module 2702 configured to send the UE status assistance operation information to an AMF via an RAN.

In summary, in the apparatus for the UE status assistance operation provided in embodiments of the present disclosure, the generating module is configured to generate the UE status assistance operation information according to the status information of the UE; and the sending module is configured to send the UE status assistance operation information to the AMF via the RAN. In embodiments of the present disclosure, it is not necessary to directly send the status information of the UE to the AMF, which may avoid a situation of the exposure of the status information of the UE. Moreover, the UE status assistance operation information may be sent to the AMF, such that a network may make a policy decision according to the requirements of the UE, thereby improving the accuracy of generating a policy-associated rule. The present disclosure provides a processing apparatus for a case of “a UE status assistance operation” to provide the UE status assistance operation information, which may provide a UE status assistance operation mechanism, and may balance the power consumption and experience quality while avoiding the exposure of the status information of the UE.

Optionally, in an embodiment of the present disclosure, the sending module 2702 is further configured to: receive the policy-associated rule sent by the AMF, in which the policy-associated rule is generated by a PCF according to the UE status assistance operation information sent by the AMF and sent to the AMF, and the policy-associated rule includes at least one of a QoS rule or a UE policy rule; and perform the policy-associated rule.

In an embodiment of the present disclosure, the status information of the UE includes at least one of: a battery level; a battery life; a powered mode; a temperature status; an overheating status; or a load status.

In an embodiment of the present disclosure, the UE status assistance operation information includes at least one of: a UE status assistance operation mode; a UE status assistance operation mode indication; threshold information; a UE status assistance operation mode function; priority information; or importance level information.

In an embodiment of the present disclosure, the UE status assistance operation mode is applied for matching traffic and an associated parameter.

In an embodiment of the present disclosure, the UE status assistance operation mode indication indicates an autonomous operation or a UE-assistance operation in a case where the UE status assistance operation mode is a mode set, in which the mode set includes at least one of a load balancing mode, a power consumption balancing mode, or a PDU set-based QoS handling mode.

In an embodiment of the present disclosure, the threshold information includes at least one of: a maximum RTT; a maximum packet loss rate; a GFBR; or an AMBR.

In an embodiment of the present disclosure, the UE status assistance operation mode function is configured to determine whether to apply the mode set for the matching traffic, in which the mode set includes at least one of the load balancing mode, the power consumption balancing mode, or the PDU set-based QoS handling mode.

In an embodiment of the present disclosure, the priority information is configured to determine a priority of whether to apply a QoS for the matching traffic, in which the priority is greater than a priority threshold.

In an embodiment of the present disclosure, the importance level information is configured to determine an importance level of whether to apply the QoS for the matching traffic, in which the importance level is greater than an importance level threshold.

In an embodiment of the present disclosure, the sending module 2702, in a case of being configured to send the UE status assistance operation information to the AMF via the RAN, is specifically configured to: send an NAS message to the AMF via the RAN, in which the NAS message includes the UE status assistance operation information.

In an embodiment of the present disclosure, the sending module 2702, in a case of being configured to send the UE status assistance operation information to the AMF via the RAN, is specifically configured to: send an NGAP message to the AMF via the RAN, in which the NGAP message includes the UE status assistance operation information.

In an embodiment of the present disclosure, the sending module 2702, in a case of being configured to send the UE status assistance operation information to the AMF via the RAN, is specifically configured to: receive a request for the UE status assistance operation information sent by the AMF via the RAN; and send the UE status assistance operation information to the AMF via the RAN in response to the request.

In an embodiment of the present disclosure, the sending module 2702, in a case of being configured to send the UE status assistance operation information to the AMF via the RAN, is specifically configured to: send the UE status assistance operation information to the AMF via the RAN in response to the UE performing a communication recovery process.

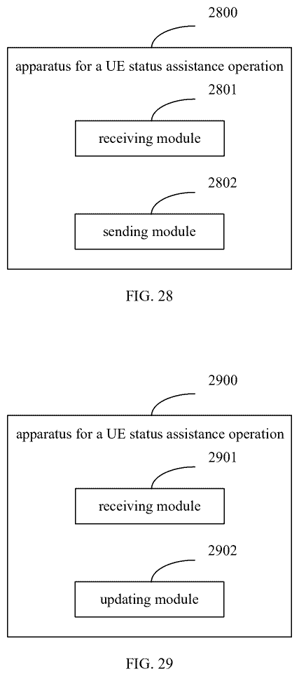

FIG. 28 is a schematic structural diagram illustrating an apparatus for a UE status assistance operation according to another embodiment of the present disclosure. As shown in FIG. 28, an apparatus 2800 may be applied to an AMF, and may include: a receiving module 2801 configured to receive UE status assistance operation information; and a sending module 2802 configured to send the UE status assistance operation information to a PCF.

In summary, in the apparatus for the UE status assistance operation provided in embodiments of the present disclosure, the receiving module is configured to receive the UE status assistance operation information; and the sending module is configured to send the UE status assistance operation information to the PCF. In embodiments of the present disclosure, it is not necessary to directly send status information of a UE to the PCF, which may avoid a situation of the exposure of the status information of the UE. Moreover, the UE status assistance operation information may be sent to the PCF, such that the PCF may make a policy decision according to the requirements of the UE, thereby improving the accuracy of generating the policy-associated rule. The present disclosure provides a processing apparatus for a case of “a UE status assistance operation” to provide the UE status assistance operation information, which may provide a UE status assistance operation mechanism, and may balance the power consumption and experience quality while avoiding the exposure of the status information of the UE.

In an embodiment of the present disclosure, the receiving module 2801 is further configured to: receive a policy-associated rule sent by the PCF, in which the policy-associated rule is generated by the PCF according to the UE status assistance operation information, and the policy-associated rule includes at least one of a QoS rule or a UE policy rule; and send the policy-associated rule to the UE.

In an embodiment of the present disclosure, the policy-associated rule includes the QoS rule, and the receiving module 2801, in a case of being configured to receive the policy-associated rule sent by the PCF, is specifically configured to: receive the QoS rule sent by the PCF via an SMF, in which the QoS rule is generated by the SMF converting a PCC rule sent by the PCF.

In an embodiment of the present disclosure, the UE status assistance operation information includes at least one of: a UE status assistance operation mode; a UE status assistance operation mode indication; threshold information; a UE status assistance operation mode function; priority information; or importance level information.

In an embodiment of the present disclosure, the threshold information includes at least one of: a maximum RTT; a maximum packet loss rate; a GFBR; or an AMBR.

In an embodiment of the present disclosure, the receiving module 2801, in a case of being configured to receive the UE status assistance operation information, is specifically configured to: receive an NAS message sent by the UE via an RAN, in which the NAS message includes the UE status assistance operation information.

In an embodiment of the present disclosure, the receiving module 2801, in a case of being configured to receive the UE status assistance operation information, is specifically configured to: receive an NGAP message sent by the UE via the RAN, in which the NGAP message includes the UE status assistance operation information, and the NGAP message is generated by the RAN converting an RRC message sent by the UE.

In an embodiment of the present disclosure, the receiving module 2801, in a case of being configured to receive the UE status assistance operation information, is specifically configured to: send a request for the UE status assistance operation information to the UE via the RAN; and receive the UE status assistance operation information sent by the UE via the RAN in response to the request.

In an embodiment of the present disclosure, the receiving module 2801, in a case of being configured to receive the UE status assistance operation information, is specifically configured to: receive the UE status assistance operation information sent by the UE via the RAN in response to the UE performing a communication recovery process.

In an embodiment of the present disclosure, the sending module 2802, in a case of being configured to send the UE status assistance operation information to the PCF, is specifically configured to: receive a subscription request sent by the PCF for the UE status assistance operation information; and send the UE status assistance operation information to the PCF in response to the subscription request and in a case where a reporting condition is satisfied.

In an embodiment of the present disclosure, the reporting condition includes at least one of: reporting in a case of receiving the UE status assistance operation information; periodical reporting; reporting in a case where at least one reporting threshold of relevant status information is reached; or reporting in a case of receiving a reporting indication.

In an embodiment of the present disclosure, the sending module 2802, in a case of being configured to send the UE status assistance operation information to the PCF, is specifically configured to: determine to send the UE status assistance operation information to the PCF according to subscription information or an operator policy.

FIG. 29 is a schematic structural diagram illustrating an apparatus for a UE status assistance operation according to another embodiment of the present disclosure. As shown in FIG. 29, an apparatus 2900 may be applied to a PCF, and may include: a receiving module 2901 configured to receive UE status assistance operation information sent by an AMF; and an updating module 2902 configured to generate or update a policy-associated rule according to the UE status assistance operation information.

In summary, in the apparatus for the UE status assistance operation provided in embodiments of the present disclosure, the receiving module is configured to receive the UE status assistance operation information sent by the AMF; and the updating module is configured to generate or update the policy-associated rule according to the UE status assistance operation information. In embodiments of the present disclosure, it is not necessary to directly receive status information of a UE, which may avoid a situation of the exposure of the status information of the UE. Moreover, the UE status assistance operation information may be received, that is, a policy decision may be made according to the requirements of the UE, thereby improving the accuracy of generating the policy-associated rule. The present disclosure provides a processing apparatus for a case of “a UE status assistance operation” to receive the UE status assistance operation information, which may provide a UE status assistance operation mechanism, and may balance the power consumption and experience quality while avoiding the exposure of the status information of the UE.

In an embodiment of the present disclosure, the updating module 2902, in a case of being configured to generate or update the policy-associated rule, is specifically configured to: update a QoS parameter of a service session and/or a service data flow of the UE; determine whether to perform PDU set-based QoS handling; or determine whether to select a different QoS profile and perform a different QoS level according to a parameter feature of a PDU set and/or a PDU set group, in which the parameter feature includes at least one of priority, importance, or dependency.

In an embodiment of the present disclosure, the QoS parameter includes at least one of: an MFBR and/or a GFBR of an uplink GBR data flow; an AMBR of an uplink non-GBR data flow; an MFBR and/or a GFBR of a downlink GBR data flow; an AMBR of a downlink non-GBR data flow; a maximum RTT; or a maximum packet loss rate.

In an embodiment of the present disclosure, the updating module 2902 is further configured to: send the policy-associated rule to the AMF.

In an embodiment of the present disclosure, the policy-associated rule includes a PCC rule, and the updating module 2902, in a case of being configured to send the policy-associated rule to the AMF, is specifically configured to: send the PCC rule to an SMF, in which the PCC rule is used by the SMF to convert the PCC rule into a QoS rule, and send the QoS rule to the AMF.

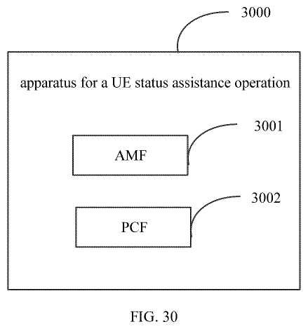

FIG. 30 is a schematic structural diagram illustrating an apparatus for a UE status assistance operation according to another embodiment of the present disclosure. As shown in FIG. 30, an apparatus 3000 may be applied to a core network, and may include: an AMF 3001 configured to receive UE status assistance operation information; in which the AMF 3001 is further configured to send the UE status assistance operation information to a PCF; the PCF 3002 is configured to receive the UE status assistance operation information sent by the AMF; and the PCF 3002 is further configured to generate or update a policy-associated rule according to the UE status assistance operation information.

In summary, in the apparatus for the UE status assistance operation provided in embodiments of the present disclosure, the AMF is configured to receive the UE status assistance operation information; the AMF is further configured to send the UE status assistance operation information to the PCF; the PCF is configured to receive the UE status assistance operation information sent by the AMF; and the PCF is further configured to generate or update the policy-associated rule according to the UE status assistance operation information. In embodiments of the present disclosure, it is not necessary to receive status information of a UE, which may avoid a situation of the exposure of the status information of the UE. Moreover, the UE status assistance operation information may be received, such that the core network may make a policy decision according to the requirements of the UE, thereby improving the accuracy of generating the policy-associated rule. The present disclosure provides a processing apparatus for a case of “a UE status assistance operation” to receive the UE status assistance operation information, which may provide a UE status assistance operation mechanism, and may balance the power consumption and experience quality while avoiding the exposure of the status information of the UE.

In an embodiment of the present disclosure, receiving the UE status assistance operation information specifically includes: the AMF receiving the UE status assistance operation information sent by an RAN.

In an embodiment of the present disclosure, generating or updating the policy-associated rule according to the UE status assistance operation information specifically includes: the AMF receiving the UE status assistance operation information; the AMF sending the UE status assistance operation information to the PCF; the PCF receiving the UE status assistance operation information sent by the AMF; and the PCF generating or updating the policy-associated rule according to the UE status assistance operation information.

In an embodiment of the present disclosure, the policy-associated rule includes a PCC rule, and the updating module 2902 is further configured to: the PCF sends the PCC rule to an SMF; and the SMF converts the PCC rule into a QoS rule and sends the QoS rule to the AMF.

In an embodiment of the present disclosure, the updating module 3002, in a case of being configured to generate or update the policy-associated rule, is specifically configured to: update a QoS parameter of a service session and/or a service data flow of the UE; determine whether to perform PDU set-based QoS handling; or determine whether to select a different QoS profile and perform a different QoS level according to a parameter feature of a PDU set and/or a PDU set group, in which the parameter feature includes at least one of priority, importance, or dependency.

In an embodiment of the present disclosure, the QoS parameter includes at least one of: an MFBR and/or a GFBR of an uplink GBR data flow; an AMBR of an uplink non-GBR data flow; an MFBR and/or a GFBR of a downlink GBR data flow; an AMBR of a downlink non-GBR data flow; a maximum RTT; or a maximum packet loss rate.

In an embodiment of the present disclosure, the updating module 2902, after generating or updating the policy-associated rule, is further configured to: send the policy-associated rule to the AMF.

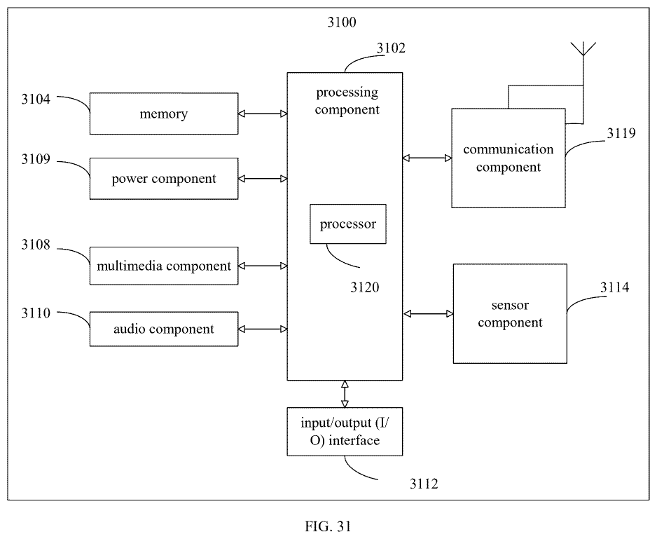

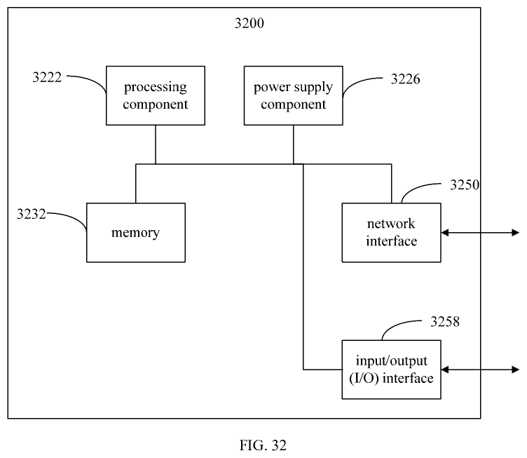

FIG. 31 is a block diagram illustrating a UE 3100 according to an embodiment of the present disclosure. For example, the UE 3100 may be a mobile phone, a computer, a digital broadcast terminal, a messaging device, a game console, a tablet device, a medical device, a fitness device, a personal digital assistant, or the like.

Referring to FIG. 31, the UE 3100 may include at least one of the following components: a processing component 3102, a memory 3104, a power component 3106, a multimedia component 3108, an audio component 3110, an input/output (I/O) interface 3112, a sensor component 3114, and a communication component 3116.

The processing component 3102 typically controls overall operations of the UE 3100, such as the operations associated with display, phone calls, data communications, camera operations, and recording operations. The processing component 3102 may include at least one processor 3120 to execute instructions to perform all or some of the steps in the above-described methods. Moreover, the processing component 3102 may include at least one module which facilitate the interaction between the processing component 3102 and other components. For instance, the processing component 3102 may include a multimedia module to facilitate the interaction between the multimedia component 3108 and the processing component 3102.

The memory 3104 is configured to store various types of data to support the operation of the UE 3100. Examples of such data include instructions for any applications or methods operated on the UE 3100, contact data, phonebook data, messages, pictures, videos, etc. The memory 3104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3106 provides power to various components of the UE 3100. The power component 3106 may include a power management system, at least one power source, and any other components associated with the generation, management, and distribution of power in the UE 3100.

The multimedia component 3108 includes a screen providing an output interface between the UE 3100 and the user. In some embodiments, the screen may include a liquid crystal display (LCD) and a touch panel (TP). If the screen includes the touch panel, the screen may be implemented as a touch screen to receive input signals from the user. The touch panel includes at least one touch sensor to sense touches, swipes, and gestures on the touch panel. The touch sensor may not only sense a boundary of a touch or swipe action, but also sense a period of time and a pressure associated with the touch or swipe action. In some embodiments, the multimedia component 3108 includes a front camera and/or a rear camera. The front camera and/or the rear camera may receive an external multimedia datum while the UE 3100 is in an operation mode, such as a photographing mode or a video mode. Each of the front camera and the rear camera may be a fixed optical lens system or have focus and optical zoom capability.

The audio component 3110 is configured to output and/or input audio signals. For example, the audio component 3110 includes a microphone (MIC) configured to receive an external audio signal when the UE 3100 is in an operation mode, such as a call mode, a recording mode, and a voice recognition mode. The received audio signal may be further stored in the memory 3104 or transmitted via the communication component 3116. In some embodiments, the audio component 3110 further includes a speaker to output audio signals.

The I/O interface 3112 provides an interface between the processing component 3102 and peripheral interface modules, such as keyboards, click wheels, buttons, and the like. The buttons may include, but are not limited to, a home button, a volume button, a starting button, and a locking button.

The sensor component 3114 includes at least one sensor to provide status assessments of various aspects of the UE 3100. For example, the sensor component 3114 may detect an open/closed status of the UE 3100, relative positioning of components, e.g., the display and the keypad, of the UE 3100, a change in position of the UE 3100 or a component of the UE 3100, a presence or absence of user contact with the UE 3100, an orientation or an acceleration/deceleration of the UE 3100, and a change in temperature of the UE 3100. The sensor component 3114 may include a proximity sensor configured to detect the presence of nearby objects without any physical contact. The sensor component 3114 may further include a light sensor, such as a CMOS or CCD image sensor, for use in imaging applications. In some embodiments, the sensor component 3114 may further include an accelerometer sensor, a gyroscope sensor, a magnetic sensor, a pressure sensor, or a temperature sensor.

The communication component 3116 is configured to facilitate communication, wired or wireless, between the UE 3100 and other devices. The UE 3100 may access a wireless network based on a communication standard, such as Wi-Fi, 2G, or 3G, or a combination thereof. In an illustrative embodiment, the communication component 3116 receives a broadcast signal or broadcast associated information from an external broadcast management system via a broadcast channel. In an illustrative embodiment, the communication component 3116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an illustrative embodiment, the UE 3100 may be implemented with at least one application specific integrated circuit (ASIC), digital signal processor (DSP), digital signal processing device (DSPD), programmable logic device (PLD), field programmable gate array (FPGA), controller, micro-controller, microprocessor, or other electronic element, for performing the above-mentioned methods.

FIG. 32 is a block diagram illustrating a network device 3200 according to an embodiment of the present disclosure. For example, the network device 3200 may be provided as a network device. Referring to FIG. 32, the network device 3200 includes a processing component 3222, which further includes at least one processor; and a memory resource represented by a memory 3232 for storing instructions executable by the processing component 3222, such as an application program. The application program stored in the memory 3232 may include one or more modules each corresponding to a set of instructions. In addition, the processing component 3222 is configured to execute instructions to perform any method of the above-mentioned methods applied to the network device.

The network device 3200 may also include a power supply component 3229 configured to perform power management of the network device 3200, a wired or wireless network interface 3250 configured to connect the network device 3200 to a network, and an input/output (I/O) interface 3258. The network device 3200 may operate based on an operating system stored in the memory 3232, such as Windows Server™, Mac OS X™, Unix™, Linux™, Free BSD™ or the like.

In the above embodiments provided in the present disclosure, the methods provided in the embodiments of the present disclosure are introduced from the perspectives of the network device and the UE respectively. In order to implement the various functions in the above-mentioned methods provided in the embodiments of the present disclosure, the network device and the UE may include a hardware structure and a software module to implement the above-mentioned various functions in the form of a hardware structure, a software module, or a hardware structure plus a software module. A certain one of the above functions may be implemented in the form of a hardware structure, a software module, or a hardware structure plus a software module.

In the above embodiments provided in the present disclosure, the methods provided in the embodiments of the present disclosure are introduced from the perspectives of the network device and the UE respectively. In order to implement the various functions in the above-mentioned methods provided in the embodiments of the present disclosure, the network device and the UE may include a hardware structure and a software module to implement the above-mentioned various functions in the form of a hardware structure, a software module, or a hardware structure plus a software module. A certain one of the above functions may be implemented in the form of a hardware structure, a software module, or a hardware structure plus a software module.

An embodiment of the present disclosure provides a communication device. The communication device may include a transceiving module and a processing module. The transceiving module may include a sending module and/or a receiving module. The sending module is used to implement a sending function, and the receiving module is used to implement a receiving function. The transceiving module may implement a sending function and/or a receiving function.

The communication device may be a terminal device (such as the terminal device in the above-mentioned method embodiments), or an apparatus in a terminal device, or a device that may be used in cooperation with a terminal device. Alternatively, the communication device may be a network device, or an apparatus in a network device, or a device that may be used in cooperation with a network device.

Another communication device is provided in an embodiment of the present disclosure. The communication device may be a network device, or may be a terminal device (such as the terminal device in the above-mentioned method embodiments), or may be a chip, a chip system, or a processor supporting the network device to implement the above-mentioned method, or may be a chip, a chip system or a processor supporting the terminal device to implement the above-mentioned method. The communication device may be used to implement the methods as described in the above-mentioned method embodiments. For details, reference may be made to the description in the above-mentioned method embodiments.

The communication device may include one or more processors. The processor may be a general-purpose processor, a special-purpose processor, or the like. It may be, for example, a baseband processor or a central processor. The baseband processor may be used to process a communication protocol and communication data, and the central processor may be used to control a communication device (such as a network device, a baseband chip, a terminal device, a terminal device chip, a DU, a CU, or the like), execute a computer program, and process data of the computer program.

In an embodiment, the communication device may further include one or more memories on which the computer program may be stored, and the processor is configured to execute the computer program to cause the communication device to perform the method as described in the above-mentioned method embodiments. In an embodiment, the memory may also have data stored therein. The communication device and the memory may be provided independently or integrated together.

In an embodiment, the communication device may further include a transceiver and an antenna. The transceiver may be referred to as a transceiving unit, a transceiving device, a transceiving circuit or the like for implementing a transceiving function. The transceiver may include a receiver and a transmitter, the receiver may be referred to as a receiving device, a receiving circuit or the like for implementing a receiving function; and the transmitter may be referred to as a transmitting device, a transmitting circuit or the like for implementing a transmitting function.

In an embodiment, the communication device may further include one or more interface circuits. The interface circuit is configured to receive and transmit a code instruction to the processor. The processor is configured to run the code instruction to enable the communication device to perform the method described in any of the above-mentioned method embodiments.

The communication device is a UE (such as the UE in the above-mentioned method embodiments), and the processor is configured to execute any one of the methods shown in FIGS. 1 to 10.

The communication device is an AMF, and the processor is configured to execute any one of the methods shown in FIGS. 11 to 20.

The communication device is a PCF, and the processor is configured to execute any one of the methods shown in FIGS. 21 to 22.

In an implementation, the processor may include a transceiver for implementing receiving and transmitting functions. For example, the transceiver may be a transceiving circuit, an interface, or an interface circuit. The transceiving circuit, the interface, or the interface circuit for implementing the receiving and transmitting functions may be separate or integrated together. The transceiving circuit, the interface or the interface circuit may be configured to read and write code/data, or may be configured to transmit or transfer signals.

In an implementation, the processor may store the computer program that, when running on the processor, enables the communication device to perform the method described in the above-mentioned method embodiments. The computer program may be embedded in the processor, in which case the processor may be implemented by hardware.

In an implementation, the communication device may include a circuit that may perform the transmitting, receiving or communicating function in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies, such as complementary metal oxide semiconductors (CMOSs), n-metal-oxide-semiconductors (NMOSs), positive channel metal oxide semiconductors (PMOSs), bipolar junction transistors (BJTs), bipolar CMOSs (BiCMOSs), silicon germanium (SiGe), gallium arsenide (GaAs), etc.

The communication device described in the above embodiments may be a network device or a terminal device (such as the terminal device in the above-mentioned method embodiments), but the scope of the communication device described in the present disclosure is not limited thereto. The structure of the communication device may not be limited. The communication device may be a stand-alone device or may be part of a larger device. For example, the communication device may be: (1) a stand-alone integrated circuit (IC), or a chip, or a chip system or subsystem; (2) a set of one or more ICs, in which for example the set of ICs may also include a storage component for storing data and computer programs; (3) an ASIC, such as a modem; (4) a module that may be embedded in other devices; (5) a receiver, a terminal device, an intelligent terminal device, a cellular phone, a wireless device, a handheld device, a mobile unit, an in-vehicle device, a network device, a cloud device, an artificial intelligence device, etc.; (6) others.

In the case where the communication device may be a chip or a chip system, the chip includes a processor and an interface. The number of processors may be one or more, and the number of interfaces may be more than one.

In an embodiment, the chip further includes a memory for storing necessary computer programs and data.

Those skilled in the art may also understand that various illustrative logical blocks and steps listed in embodiments of the present disclosure may be implemented by an electronic hardware, a computer software, or a combination thereof. Whether such functions are implemented by a hardware or a software depends on specific applications and design requirements of an overall system. For each specific application, those skilled in the art may use various methods to implement the function, but such an implementation should not be understood as extending beyond the protection scope of embodiments of the present disclosure.

The present disclosure further provides a readable storage medium having stored therein instructions that, when executed by a computer, cause functions of any one of the above method embodiments to be implemented.

The present disclosure further provides a computer program product that, when executed by a computer, causes functions of any one of the above method embodiments to be implemented.

All or some of the above embodiments may be implemented by a software, a hardware, a firmware or any combination thereof. When implemented using the software, all or some of the above embodiments may be implemented in a form of the computer program product. The computer program product includes one or more computer programs. When the computer program is loaded and executed on the computer, all or some of the processes or functions according to embodiments of the present disclosure will be generated. The computer may be a general-purpose computer, a special-purpose computer, a computer network, or other programmable devices. The computer program may be stored in a computer-readable storage medium, or transmitted from one computer-readable storage medium to another computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (for example, in an infrared, wireless, or microwave manner, or the like). The computer-readable storage medium may be any available medium that may be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), a semiconductor medium (for example, a solid state disk (SSD)), or the like.

Those of ordinary skill in the art may understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the terms “first”, “second”, “third”, “A”, “B”, “C” and “D” have no order of precedence or size.

Other embodiments of the present disclosure will be apparent to those skilled in the art from consideration of the specification and practice of the present disclosure disclosed here. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for a user equipment (UE) status assistance operation, performed by a UE, comprising:
generating UE status assistance operation information according to status information of the UE; and
sending the UE status assistance operation information to an access and mobility management function (AMF) via a radio access network (RAN).

2. The method of claim 1, wherein the status information of the UE comprises at least one of:
a battery level;
a battery life;
a powered mode;
a temperature status;
an overheating status; or
a load status.

3. The method of claim 1, wherein the UE status assistance operation information comprises at least one of:
a UE status assistance operation mode;
a UE status assistance operation mode indication;
threshold information;
a UE status assistance operation mode function;
priority information; or
importance level information.

4. The method of claim 3, wherein the method meets at least one condition of:
the UE status assistance operation mode is applied for matching traffic and an associated parameter;
the UE status assistance operation mode indication indicates an autonomous operation or a UE-assistance operation in response to the UE status assistance operation mode being a mode set, wherein the mode set comprises at least one of a load balancing mode, a power consumption balancing mode, or a packet data unit (PDU) set-based quality of service (QoS) handling mode;
the threshold information comprises at least one of: a maximum round-trip time (RTT), a maximum packet loss rate, a guaranteed flow bit rate (GFBR), or an aggregated maximum bit rate (AMBR);
the UE status assistance operation mode function determines whether to apply a mode set for matching traffic, wherein the mode set comprises at least one of a load balancing mode, a power consumption balancing mode, or a PDU set-based QoS handling mode;
the priority information determines a priority of whether to apply a QoS for matching traffic, wherein the priority is greater than a priority threshold; or
the importance level information determines an importance level of whether to apply a QoS for matching traffic, wherein the importance level is greater than an importance level threshold.

5-9. (canceled)

10. The method of claim 1, wherein sending the UE status assistance operation information to the AMF via the RAN comprises at least one of:
sending a non-access stratum (NAS) message to the AMF via the RAN, wherein the NAS message comprises the UE status assistance operation information;
sending a next generation application protocol (NGAP) message to the AMF via the RAN, wherein the NGAP message comprises the UE status assistance operation information;
receiving a request for the UE status assistance operation information sent by the AMF via the RAN, and sending the UE status assistance operation information to the AMF via the RAN in response to the request; or
sending the UE status assistance operation information to the AMF via the RAN in response to the UE performing a communication recovery process.

11-13. (canceled)

14. A method for a user equipment (UE) status assistance operation, performed by an access and mobility management function (AMF), comprising:
receiving UE status assistance operation information; and
sending the UE status assistance operation information to a protocol control frame (PCF).

15. The method of claim 14, further comprising:
receiving a policy-associated rule sent by the PCF, wherein the policy-associated rule is generated by the PCF according to the UE status assistance operation information, and the policy-associated rule comprises at least one of a quality of service (QoS) rule or a UE policy rule; and
sending the policy-associated rule to a UE.

16. The method of claim 15, wherein the policy-associated rule comprises the QoS rule, and receiving the policy-associated rule sent by the PCF comprises:
receiving the QoS rule sent by the PCF via a session management function (SMF), wherein the QoS rule is generated by the SMF converting a policy control and charging (PCC) rule sent by the PCF.

17-18. (canceled)

19. The method of claim 14, wherein receiving the UE status assistance operation information comprises at least one of:
receiving a non-access stratum (NAS) message sent by a UE via a radio access network (RAN), wherein the NAS message comprises the UE status assistance operation information;
receiving a next generation application protocol (NGAP) message sent by a UE via an RAN, wherein the NGAP message comprises the UE status assistance operation information, and the NGAP message is generated by the RAN converting a radio resource control (RRC) message sent by the UE;
sending a request for the UE status assistance operation information to a UE via an RAN, and receiving the UE status assistance operation information sent by the UE via the RAN in response to the request; or
receiving the UE status assistance operation information sent by a UE via an RAN in response to the UE performing a communication recovery process.

20-22. (canceled)

23. The method of claim 14, wherein sending the UE status assistance operation information to the PCF comprises:
receiving a subscription request sent by the PCF for the UE status assistance operation information; and
sending the UE status assistance operation information to the PCF in response to the subscription request and in response to a reporting condition is being satisfied.

24. The method of claim 23, wherein the reporting condition comprises at least one of:
reporting in response to receiving the UE status assistance operation information;
periodical reporting;
reporting in response to at least one reporting threshold of relevant status information being reached; or
reporting in response to of receiving a reporting indication.

25. The method of claim 14, wherein sending the UE status assistance operation information to the PCF comprises:
determining to send the UE status assistance operation information to the PCF according to subscription information or an operator policy.

26. A method for a user equipment (UE) status assistance operation, performed by a protocol control frame (PCF), comprising:
receiving UE status assistance operation information sent by an access and mobility management function (AMF); and
generating or updating a policy-associated rule according to the UE status assistance operation information.

27. The method of claim 26, wherein generating or updating the policy-associated rule comprises at least one of:
updating a quality of service (QoS) parameter of at least one of a service session or a service data flow of a UE;
determining whether to perform packet data unit (PDU) set-based QoS handling; or
determining whether to select a different QoS profile and perform a different QoS level according to a parameter feature of at least one of a PDU set or a PDU set group, wherein the parameter feature comprises at least one of priority, importance, or dependency.

28. The method of claim 27, wherein the QoS parameter comprises at least one of:
at least one of a maximum flow bit rate (MFBR) or a guaranteed flow bit rate (GFBR) of an uplink guaranteed bit rate (GBR) data flow;
an aggregate maximum bit rate (AMBR) of an uplink non-guaranteed bit rate (non-GBR) data flow;
at least one of an MFBR or a GFBR of a downlink GBR data flow;
an AMBR of a downlink non-GBR data flow;
a maximum round-trip time (RTT); or
a maximum packet loss rate.

29. The method of claim 26, further comprising:
sending the policy-associated rule to the AMF.

30. The method of claim 29, wherein the policy-associated rule comprises a policy control and charging (PCC) rule, and sending the policy-associated rule to the AMF comprises:
sending the PCC rule to a session management function (SMF), wherein the PCC rule is used by the SMF to convert the PCC rule into a QoS rule, and send the QoS rule to the AMF.

31-38. (canceled)

39. A user equipment (UE), comprising:
a processor; and
a memory,
wherein the memory is configured to store a computer program, and the processor is configured to execute the computer program stored in the memory to cause the UE to perform the method of claim 1.

40. An access and mobility management function (AMF), comprising:
a processor; and
a memory,
wherein the memory is configured to store a computer program, and the processor is configured to execute the computer program stored in the memory to cause the AMF to perform the method of claim 14.

41. A protocol control frame (PCF), comprising:
a processor, and
a memory,
wherein the memory is configured to store a computer program, and the processor is configured to execute the computer program stored in the memory to cause the PCF to perform the method of claim 26.

42-45. (canceled)
